(19) United States
(12) Patent Application Publication
(10) Pub. No.: US 2009/0117266 A1
(43) Pub. Date: May 7, 2009

(54) NEAR-INFRARED-ABSORBING MATERIAL

(76) Inventors: Keizo Kimura, Kanagawa (JP); Katsuyoshi Yamakawa, Kanagawa (JP)

Correspondence Address: BIRCH STEWART KOLASCH & BIRCH, PO BOX 747, FALLS CHURCH, VA, 22040-0747, US

(21) Appl. No.: 12/295,283

(22) PCT Filed: Mar. 12, 2007
(86) PCT No.: PCT/JP2007/055320

§ 371 Date: Sep. 29, 2008

(30) Foreign Application Priority Data
Mar. 27, 2006 (JP) 2006-086594

(51) Int. Cl. B05D 3/02

(52) U.S. Cl. 427/160

(57) ABSTRACT

The invention provides a near-infrared-absorbing material, comprising at least two ultraviolet absorbents and at least one near-infrared absorbent or infrared absorbent, wherein the at least two ultraviolet absorbents are at least two compounds having a maximum spectroscopic absorption wavelength in solution of 470 nm or less in a wavelength range of from 270 to 1,600 nm and the at least one near-infrared or infrared absorbent is at least one compound having a maximum spectroscopic absorption wavelength in solution of 700 nm or more in a wavelength range of from 400 to 1,600 nm.

The disclosure of Japanese Patent Application No. 2006-086594 is incorporated herein by the reference in its entirety.

### TECHNICAL FIELD

The present invention relates to a near-infrared-absorbing material, in particular to a near-infrared-absorbing material superior both in light resistance and other physical properties, that plays an important role in optoelectronic applications such as near-infrared-absorbing filters, near-infrared-absorbing colored resin compositions, liquid crystal display elements, optical cards, optical recording media, and protective goggles.

### BACKGROUND ART

Near-infrared-absorbing colorants absorbing practically no visible light but absorbing infrared light have been used in various optoelectronic products such as near-infrared-absorbing filters. These colorants have occasionally had a problem of decomposition, when exposed to high temperature, high humidity or photoirradiation, according to the application thereof. Although naphthalocyanine colorants in specific structures, for example, are known to be effective in improving resistance to these conditions by modification of the structure of the colorant (see, for example, Japanese Patent Application Laid-Open (JP-A) Nos. 2-4635, 2-43269 and 2-338382), it has been difficult to improve the resistance and other physical properties such as absorption wavelength and solubility at the same time. Alternatively, methods of suppressing photodegradation by combined use of a near-infrared-absorbing colorant and an ultraviolet-absorbing material are known (see, for example, JP-A Nos. 11-167350, 2001-133624 and 2005-181966), none of these methods are sufficiently preventive and, thus, there exists a need for a method of further improving the light resistance.

### DISCLOSURE OF INVENTION

An object of the present invention is to provide a near-infrared-absorbing material superior both in light resistance and other physical properties that plays an important role in optoelectronic applications such as near-infrared-absorbing filters, near-infrared-absorbing colored resin compositions, liquid crystal display elements, optical cards, optical recording media, and protective goggles.

The present inventors extensively made a study of the near-infrared-absorbing material, and discovered that the above described object can be achieved by the following items <1> to <12>.

<1> A near-infrared-absorbing material, comprising at least two ultraviolet absorbents; and at least one near-infrared absorbent or infrared absorbent.

<2> The near-infrared-absorbing material of item <1>, wherein the at least two ultraviolet absorbents are at least two compounds having a maximum spectroscopic absorption wavelength in solution of 470 nm or less in a wavelength range of from 270 to 1,600 nm.

<3> The near-infrared-absorbing material of item <1>, wherein the at least one near-infrared absorbent or infrared absorbent is at least one compound having a maximum spectroscopic absorption wavelength in solution of 700 nm or more in a wavelength range of from 400 to 1,600 nm n.

<4> The near-infrared-absorbing material of items <2> or <3>, wherein the at least two ultraviolet absorbents have a maximum spectroscopic absorption wavelength of 430 nm or less and the at least one near-infrared absorbent or infrared absorbent has a maximum spectroscopic absorption wavelength of 730 nm or more.

<5> The near-infrared-absorbing material of item <4>, wherein the at least two ultraviolet absorbents have a maximum spectroscopic absorption wavelength of 410 nm or less and the at least one near-infrared absorbent or infrared absorbent has a maximum spectroscopic absorption wavelength of 760 nm or more.

<6> The near-infrared-absorbing material of item <5>, wherein the at least two ultraviolet absorbents have a maximum spectroscopic absorption wavelength of 380 nm or less and the at least one near-infrared absorbent or infrared absorbent has a maximum spectroscopic absorption wavelength of 780 nm or more.

<7> The near-infrared-absorbing material of any one of items <2> to <6>, wherein the at least two ultraviolet absorbents are compounds selected from compounds represented by the following Formulae (I-1), (I-2), (I-3), (I-4) and (I-5):

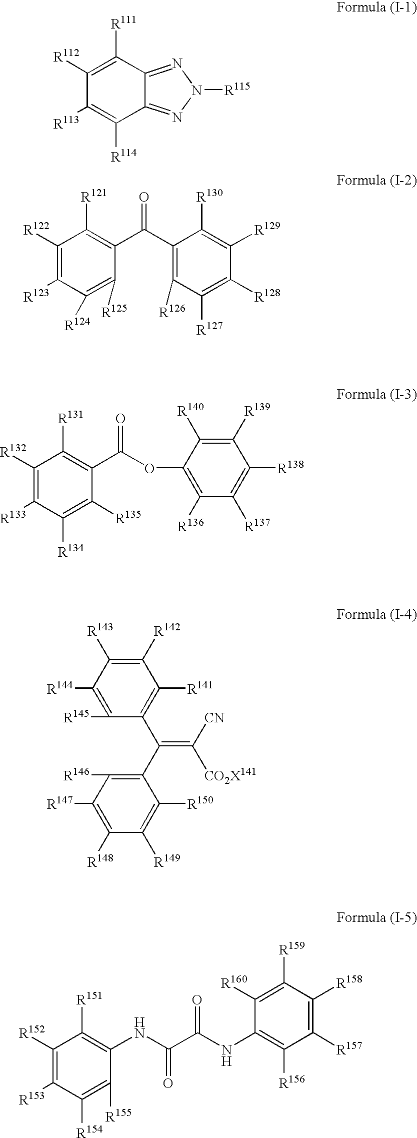

wherein, in Formulae I-1 to I-5, R¹¹¹ to R¹¹⁴, R¹²¹ to R¹³⁰, R¹³¹ to R¹⁴⁰, R¹⁴¹ to R¹⁵⁰, and R¹⁵¹ to R¹⁶⁰ each independently represent a hydrogen atom or a substituent group; R¹¹⁵ represents a hydrogen atom, an aliphatic group, an aromatic group or a heterocyclic group binding at a carbon atom; X¹⁴¹ represents a hydrogen atom, an aliphatic group, an aromatic group or a heterocyclic group binding at a carbon atom; and among R¹¹¹ to R¹¹⁴, R¹²¹ to R¹³⁰, R¹³¹ to R¹⁴⁰, R¹⁴¹ to R¹⁵⁰, and R¹⁵¹ to R¹⁶⁰, neighboring substituent groups on benzene ring in each Formula may bind to each other to form a ring.

<8> The near-infrared-absorbing material of item <7>, wherein the at least two ultraviolet absorbents are a combination of compounds respectively selected from the different Formula selected from the Formulae (I-1) to (I-5).

<9> The near-infrared-absorbing material of items <7> or <8>, wherein the at least two ultraviolet absorbents include at least one compound represented by the Formula (I-1).

<10> The near-infrared-absorbing material of any one of items <8> or <9>, wherein the at least two ultraviolet absorbents contain at least one compound selected from Formula (I-2), (I-3), (I-4) or (I-5).

<11> The near-infrared-absorbing material of any one of items <2> to <10>, wherein the at least one near-infrared absorbent or infrared absorbent compound is a compound represented by the following Formula (II-1):

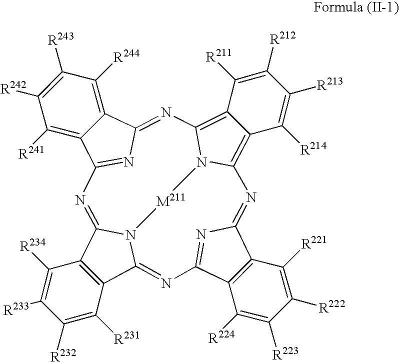

wherein, in Formula (II-1), R²¹¹ to R²⁴⁴ each independently represent a hydrogen atom or a substituent group; among R²¹¹ to R²⁴⁴, neighboring substituent groups on a benzene ring, may bind to each other to form a ring; M²¹¹ represents two atoms selected from the group consisting of a hydrogen atom and monovalent metal atoms, a divalent metal atom, or a divalent substituted metal atom including a trivalent or quadrivalent metal atom.

<12> The near-infrared-absorbing material of any one of items <2> to <11>, wherein the at least two ultraviolet absorbents and the at least one near-infrared absorbent or infrared absorbent compound are present in a single layer.

<13> The near-infrared-absorbing material of any one of items <2> to <12>, wherein the total mole number of the at least two ultraviolet absorbents is 0.1 mole or more with respect to 1 mole of the at least one near-infrared absorbent or infrared absorbent.

The invention provides a near-infrared-absorbing material superior both in light resistance and other physical properties that plays an important role in the field of optoelectronics such as infrared ray absorption filters, near-infrared ray absorption colored resin compositions, liquid crystal display elements, optical cards, optical recording media, and protective goggles.

### BEST MODE FOR CARRYING OUT THE INVENTION

Hereinafter, preferable embodiments of the present invention will be described in detail.

The invention relates to a near-infrared-absorbing material, comprising “at least two ultraviolet absorbents”, and “at least one near-infrared absorbent or infrared absorbent”.

The ultraviolet absorbent is, specifically in characterizing properties, a compound having a maximum spectroscopic absorption wavelength in solution of 470 nm or less in a wavelength range of 270 to 1,600 nm in solution, while the near-infrared absorbent or infrared absorbent is, specifically in characterizing properties, a compound having a maximum spectroscopic absorption wavelength of 700 nm or more in a wavelength range of 400 to 1,600 in solution.

Hereinafter, the ultraviolet absorbent may be thus referred to as a compound having a maximum spectroscopic absorption wavelength in solution of 470 nm or less in a wavelength range of 270 to 1,600 nm, while the near-infrared absorbent or infrared absorbent, a compound having a maximum spectroscopic absorption wavelength of 700 nm or more in a wavelength range of 400 to 1,600 in solution.

The aspect of containing these compounds is not particularly limited, and thus, for example, “at least two ultraviolet absorbents” and “at least one near-infrared absorbent or infrared absorbent” may be present in separate layers or alternatively, co-present in a same layer.

Among these aspects, these compounds are preferably co-present in the same layer, for acceleration of solubilization respectively of the ultraviolet absorbents and the near-infrared or infrared absorbent.

<Maximum Spectroscopic Absorption Wavelength>

Hereinafter, the term maximum spectroscopic absorption wavelength will be described.

The maximum spectroscopic absorption wavelength is determined form an absorption spectrum in solution, and any solvent may be used, if the compound is soluble therein. The solvent may be an organic or inorganic solvent, or water, and the mixture thereof may also be used. The maximum spectroscopic absorption wavelength is in the range defined in the invention under any condition, if a solvent and a temperature at which the compound is soluble are used in the invention.

Examples of the organic solvents include amide-based solvents (such as N,N-dimethylformamide, N,N-dimethylacetamide, and 1-methyl-2-pyrrolidone), sulfone-based solvents (such as sulfolane), sulfoxide-based solvents (such as dimethylsulfoxide), ureide-based solvents (such as tetramethylurea), ether-based solvents (such as dioxane, tetrahydrofuran, and cyclopentylmethylether), ketone-based solvents (such as acetone and cyclohexanone), hydrocarbon-based solvents (such as toluene, xylene, and n-decane), halogenated solvents (such as tetrachloroethane, chlorobenzene, and chloronaphthalene), alcohol-based solvents (such as methanol, ethanol, isopropylalcohol, ethylene glycol, cyclohexanol, and phenol), pyridine-based solvents (such as pyridine, r-picoline, and 2,6-lutidine), ester-based solvents (such as ethyl butyrate and butyl acetate), carboxylic acid-based solvents (such as acetic acid and propionic acid), nitrile-based solvents (such as acetonitrile), sulfonic acid-based solvents (such as methanesulfonic acid), and amine-based solvents (such as triethylamine and tributylamine); and examples of the inorganic solvents include sulfuric acid and phosphoric acid.

Examples of the solvents preferable among these solvents for the compounds defined in “at least two ultraviolet absorbents” at the maximum spectroscopic absorption wavelength include amide-based solvents, sulfone-based solvents, sulfoxide-based solvents, ureide-based solvents, ether-based solvents, ketone-based solvents, halogenated solvents, alcohol-based solvents, ester-based solvents, and nitrile-based solvents; particularly preferable are ethyl acetate and N,N-dimethylformamide; on the other hand, examples of the solvents preferable for the compound defined in “at least one near-infrared absorbent or infrared absorbent” at the maximum spectroscopic absorption wavelength include amide-based solvents, sulfone-based solvents, sulfoxide-based solvents, ureide-based solvents, ether-based solvents, hydrocarbon-based solvents, halogenated solvents, sulfonic acid-based solvents, and sulfuric acid; and particularly preferable are tetrahydrofuran and sulfuric acid.

The concentration of the compound for determination of the maximum spectroscopic absorption wavelength is not particularly limited, as long as the maximum wavelength of spectroscopic absorption can be determined, but preferably in the range of 1×10⁻¹³ to 1×10⁻⁷ (mol/l). The temperature is not particularly limited, but preferably 0° C. to 80° C., a most preferably room temperature (25° C.) as long as the compound is soluble without problem.

The analyzer for use may be a common spectroscopic absorption analyzer (such as U-4100 spectrophotometer, manufactured by Hitachi High-Technologies Corporation).

<Groups in the Invention>

The groups in the invention will be described in detail, before the compound is described.

The aliphatic group in the present specification means an alkyl group, a substituted alkyl group, an alkenyl group, a substituted alkenyl group, an alkynyl group, a substituted alkynyl group, an aralkyl group or a substituted aralkyl group. The alkyl group may be a branched or cyclic group. The number of carbon atoms in the alkyl group is preferably 1 to 20, more preferably 1 to 18. The alkyl unit in the substituted alkyl group is the same as the above alkyl group. The alkenyl group may be a branched or cyclic ring. The number of carbon atoms in the alkenyl group is preferably 2 to 20, more preferably 2 to 18. The alkenyl unit in the substituted alkenyl group is the same as the alkenyl group above. The alkynyl group may be a branched or cyclic group. The number of carbon atoms in the alkynyl group is preferably 2 to 20, more preferably 2 to 18. The alkynyl unit in the substituted alkynyl group is the same as the alkynyl group above. The alkyl unit in the aralkyl group and substituted aralkyl group is the same as the alkyl group above. The aryl unit in the aralkyl group and substituted aralkyl group is the same as the aryl group below.

Examples of the substituent groups in the substituted alkyl group, substituted alkenyl group, or substituted alkynyl group, or in the alkyl unit in the substituted aralkyl group include halogen atoms (such as chlorine, bromine, and iodine); alkyl groups [straight-chain, branched, or cyclic substituted or unsubstituted alkyl group; specific examples thereof include alkyl groups preferably alkyl groups having 1 to 30 carbon atoms, such as methyl, ethyl, n-propyl, isopropyl, t-butyl, n-octyl, eicosyl, 2-chloroethyl, 2-cyanoethyl, and 2-ethylhexyl), cycloalkyl groups (preferably substituted or unsubstituted cycloalkyl groups having 3 to 30 carbon atoms, such as cyclohexyl, cyclopentyl, and 4-n-dodecylcyclohexyl), bicycloalkyl groups (preferably substituted or unsubstituted bicycloalkyl groups having 5 to 30 carbon atoms, i.e., monovalent groups of bicycloalkanes having 5 to 30 carbon atoms from which a hydrogen atom is removed, such as bicyclo[1,2,2]heptan-2-yl and bicyclo[2,2,2]octan-3-yl), tricyclic structures having more ring structures, and the like; and the alkyl group in the substituent group described below (e.g., alkyl group in alkylthio group) is also the alkyl group in the same meaning]; alkenyl groups [straight-chain, branched, or cyclic substituted or unsubstituted alkenyl groups; alkenyl groups (including preferably substituted or unsubstituted alkenyl groups having 2 to 30 carbon atoms, such as vinyl, allyl, prenyl, geranyl, and oleyl), including cycloalkenyl groups (preferably, substituted or unsubstituted cycloalkenyl groups having 3 to 30 carbon atoms, i.e., monovalent groups of a cycloalkene having 3 to 30 carbon atoms from which a hydrogen atom is removed such as 2-cyclopenten-1-yl and 2-cylcohexen-1-yl), and bicycloalkenyl groups (substituted or unsubstituted bicycloalkenyl groups, preferably substituted or unsubstituted bicycloalkenyl groups having 5 to 30 carbon atoms, i.e., monovalent groups of a bicycloalkene having a double bond from which a hydrogen atom is removed, such as bicyclo[2,2,1]hept-2-en-1-yl and bicyclo[2,2,2]oct-2-en-4-yl)], alkynyl groups (preferably substituted or unsubstituted alkynyl groups having 2 to 30 carbon atoms, such as ethynyl, propargyl, and trimethylsilylethynyl),

aryl groups (preferably substituted or unsubstituted aryl groups having 6 to 30 carbon atoms, such as phenyl, p-toluoyl, naphthyl, m-chlorophenyl, and o-hexadccanoylaminophenyl), heterocyclic groups (monovalent groups, preferably five- or six-membered substituted or unsubstituted, aromatic or nonaromatic heterocyclic compounds from which a hydrogen atom is removed, more preferably, five- or six-membered heteroaromatic ring groups having 3 to 30 carbon atoms, such as 2-furyl, 2-thienyl, 2-pyrimidinyl, and 2-benzothiazolyl), a cyano group, a hydroxyl group, a nitro group, a carboxyl group, alkoxy groups (preferably substituted or unsubstituted alkoxy groups having 1 to 30 carbon atoms, such as methoxy, ethoxy, isopropoxy, t-butoxy, n-octyloxy, and 2-methoxyethoxy), aryloxy groups (preferably substituted or unsubstituted aryloxy groups having 6 to 30 carbon atoms, such as phenoxy, 2-methylphenoxy, 4-t-butylphenoxy, 3-nitrophenoxy, and 2-tetradecanoylaminophenoxy), silyloxy groups (preferably silyloxy groups having 3 to 20 carbon atoms, such as trimethylsilyloxy and t-butyldimethylsilyloxy), heterocyclic oxy groups (preferably substituted or unsubstituted heterocyclic oxy groups having 2 to 30 carbon atoms, such as 1-phenyltetrazole-5-oxy and 2-tetrahydropyranyloxy), acyloxy groups (preferably formyloxy group, substituted or unsubstituted alkylcarbonyloxy groups having 2 to 30 carbon atoms, and substituted or unsubstituted arylcarbonyloxy groups having 6 to 30 carbon atoms, such as formyloxy, acetyloxy, pivaloyloxy, stearoyloxy, benzoyloxy, and p-methoxyphenylcarbonyloxy), carbamoyloxy groups (preferably substituted or unsubstituted carbamoyloxy group having 1 to 30 carbon atoms, such as N,N-dimethylcarbamoyloxy, N,N-diethylcarbamoyloxy, morpholinocarbonyloxy, N,N-di-n-octylaminocarbonyloxy, and N-n-octylcarbamoyloxy), alkoxycarbonyloxy groups (preferably substituted or unsubstituted alkoxycarbonyloxy groups having 2 to 30 carbon atoms, such as methoxycarbonyloxy, ethoxycarbonyloxy, t-butoxycarbonyloxy, and n-octylcarbonyloxy), aryloxycarbonyloxy groups (preferably substituted or unsubstituted aryloxycarbonyloxy group having 7 to 30 carbon atoms, such as phenoxycarbonyloxy, p-methoxyphenoxycarbonyloxy, and p-n-hexadecyloxyphenoxycarbonyloxy),

amino groups (preferably an amino group, substituted or unsubstituted alkylamino groups having 1 to 30 carbon atoms, and substituted or unsubstituted anilino groups having 6 to 30 carbon atoms, such as amino, methylamino, dimethylamino, anilino, N-methyl-anilino, and diphenylamino), acylamino groups (preferably a formylamino group, substituted or unsubstituted alkylcarbonylamino groups having 1 to 30 carbon atoms, and substituted or unsubstituted arylcarbonylamino group having 6 to 30 carbon atoms, such as formylamino, acetylamino, pivaloylamino, lauroylamino, benzoylamino, and 3,4,5-tri-n-octyloxyphenylcarbonylamino), aminocarbonylamino groups (preferably substituted or unsubstituted aminocarbonylamino groups having 1 to 30 carbon atoms, such as carbamoylamino, N,N-dimethylaminocarbonylamino, N,N-diethylaminocarbonylamino, and morpholinocarbonylamino), alkoxycarbonylamino groups (preferably substituted or unsubstituted alkoxycarbonylamino groups having 2 to 30 carbon atoms, such as methoxycarbonylamino, ethoxycarbonylamino, t-butoxycarbonylamino, n-octadecyloxycarbonylamino, and N-methyl-methoxycarbonylamino), aryloxycarbonylamino groups (preferably, substituted or unsubstituted aryloxycarbonylamino groups having 7 to 30 carbon atoms, such as phenoxycarbonylamino, p-chlorophenoxycarbonylamino, and m-n-octyloxyphenoxycarbonylamino), sulfamoylamino groups (preferably substituted or unsubstituted sulfamoylamino group having 0 to 30 carbon atoms, such as sulfamoylamino, N,N-dimethylaminosulfonylamino, and N-n-octylaminosulfonylamino), alkyl and arylsulfonylamino groups (preferably substituted or unsubstituted alkylsulfonylamino groups having 1 to 30 carbon atoms and substituted or unsubstituted arylsulfonylamino groups having 6 to 30 carbon atoms, such as methylsulfonylamino, butylsulfonylamino, phenylsulfonylamino, 2,3,5-trichlorophenylsulfonylamino, and p-methylphenylsulfonylamino), a mercapto group,

alkylthio groups (preferably substituted or unsubstituted alkylthio group having 1 to 30 carbon atoms, such as methylthio, ethylthio, and n-hexadecylthio), arylthio groups (preferably substituted or unsubstituted arylthio groups having 6 to 30 carbon atoms, such as phenylthio, p-chlorophenylthio, and m-methoxyphenylthio), heterocyclic thio groups (preferably substituted or unsubstituted heterocyclic thio groups having 2 to 30 carbon atoms, such as 2-benzothiazolylthio and 1-phenyltetrazol-5-ylthio), sulfamoyl groups (preferably substituted or unsubstituted sulfamoyl groups having 0 to 30 carbon atoms, such as N-ethylsulfamoyl, N-(3-dodecyloxypropyl)sulfamoyl, N,N-dimethylsulfamoyl, N-acetylsulfamoyl, N-benzoylsulfamoyl, and N—(N′-pheylcarbamoyl)sulfamoyl), a sulfo group, alkyl- or aryl-sulfinyl groups (preferably, substituted or unsubstituted alkylsulfinyl groups having 1 to 30 carbon atoms and substituted or unsubstituted arylsulfinyl group having 6 to 30 carbon atoms, such as methylsulfinyl, ethylsulfinyl, phenylsulfinyl, and p-methylphenylsulfinyl),

alkyl or arylsulfonyl groups (preferably substituted or unsubstituted alkylsulfonyl groups having 1 to 30 carbon atoms and substituted or unsubstituted arylsulfonyl groups having 6 to 30 carbon atoms, such as methylsulfonyl, ethylsulfonyl, phenylsulfonyl, and p-methylphenylsulfonyl), acyl groups (preferably a formyl group, substituted or unsubstituted alkylcarbonyl groups having 2 to 30 carbon atoms, substituted or unsubstituted aryloxycarbonyl groups having 7 to 30 carbon atoms, and heterocyclic carbonyl groups having a carbonyl group bound to a substituted or unsubstituted carbon group having 4 to 30 carbon atoms, such as acetyl, pivaloyl, 2-chloroacetyl, stearoyl, benzoyl, p-n-octyloxyphenylcarbonyl, 2-pyridylcarbonyl, and 2-furylcarbonyl), aryloxycarbonyl groups (preferably substituted or unsubstituted aryloxycarbonyl groups having 7 to 30 carbon atoms, such as phenoxycarbonyl, o-chlorophenoxycarbonyl, m-nitrophenoxycarbonyl, and p-t-butylphenoxycarbonyl), alkoxycarbonyl groups (preferably substituted or unsubstituted alkoxycarbonyl groups having 2 to 30 carbon atoms, such as methoxycarbonyl, ethoxycarbonyl, t-butoxycarbonyl, and n-octadecyloxycarbonyl), carbamoyl groups (preferably substituted or unsubstituted carbamoyl groups having 1 to 30 carbon atoms, such as carbamoyl, N-methylcarbamoyl, N,N-dimethylcarbamoyl, N,N-di-n-octylcarbamoyl, and N-(methylsulfonyl)carbamoyl),

aryl or heterocyclic azo groups (preferably substituted or unsubstituted aryl azo groups having 6 to 30 carbon atoms and substituted or unsubstituted heterocyclic azo groups having 3 to 30 carbon atoms, such as phenylazo, p-chlorophenylazo, and 5-ethylthio-1,3,4-thiadiazol-2-ylazo), imido groups (preferably, N-succinimido and N-phthalimido), phosphino groups (preferably substituted or unsubstituted phosphino groups having 2 to 30 carbon atoms, such as dimethylphosphino, diphenylphosphino, and methylphenoxyphosphino), phosphinyl groups (preferably substituted or unsubstituted phosphinyl groups having 2 to 30 carbon atoms, such as phosphinyl, dioctyloxyphosphinyl, and diethoxyphosphinyl), phosphinyloxy groups (preferably substituted or unsubstituted phosphinyloxy groups having 2 to 30 carbon atoms, such as diphenoxyphosphinyloxy and dioctyloxyphosphinyloxy), phosphinylamino groups (preferably substituted or unsubstituted phosphinylamino groups having 2 to 30 carbon atoms, such as dimethoxyphosphinylamino and dimethylaminophosphinylamino), silyl groups (preferably substituted or unsubstituted silyl groups having 3 to 30 carbon atoms, such as trimethylsilyl, t-butyldimethylsilyl, and phenyldimethylsilyl), and the like.

The functional groups above containing hydrogen atoms may be removed of its hydrogen atoms and substituted with one of the groups above. Examples of the functional groups include alkylcarbonylaminosulfonyl groups, arylcarbonylaminosulfonyl groups, alkylsulfonylaminocarbonyl groups, and arylsulfonylaminocarbonyl groups. Specific examples thereof include groups such as methylsulfonylaminocarbonyl, p-methylphenylsulfonylaminocarbonyl, acetylaminosulfonyl, and benzoylaminosulfonyl, Substituent groups to the aryl unit in the substituted aralkyl group include the substituent groups to the following substituted aryl group.

The aromatic group in the present specification means an aryl group or a substituted aryl group. These aromatic groups may be fused with an aliphatic ring, another aromatic ring or a hetero ring. The number of carbon atoms in the aromatic group is preferably 6 to 40, more preferably, 5 to 30, and still more preferably 6 to 20. Among them, the aryl group is particularly preferably a phenyl or naphthyl group that may have substituent, particularly preferably a phenyl group that may have substituent.

Examples of the substituent groups of the substituted aryl group include those described as the “substituent groups of the alkyl unit in the substituted alkyl group, substituted alkenyl group, substituted alkynyl group, and of substituted aralkyl group” described above.

The heterocyclic group in the present specification contains at least one heteroatom as a ring atom, and the ring may be saturated or unsaturated, aromatic or non-aromatic, and fused or unfused with another ring forming a fused ring, and also, may have substituent. The ring is preferably a four- to eight-membered ring.

In the invention, an aromatic five- or six-membered saturated or unsaturated heterocyclic ring is preferably contained. The heterocyclic ring may be fused with an aliphatic or aromatic ring or another heterocyclic ring. The heteroatom in the heterocyclic ring is preferably B, N, O, S, Se or Te. Among them, the heteroatom in the heterocyclic ring is preferably N, O or S. The heterocyclic ring is preferably a monovalent group having a free carbon atom (the heterocyclic group binds at the carbon atom). The number of carbon atoms in the heterocyclic group is preferably 1 to 40, more preferably 1 to 30, and still more preferably 1 to 20. Examples of the saturated heterocyclic rings include pyrrolidine ring, morpholine ring, 2-bora-1,3-dioxolane ring and 1,3-thiazolidine ring. Examples of the unsaturated heterocyclic rings include imidazole ring, thiazole ring, benzothiazole ring, benzoxazole ring, benzotriazole ring, benzoselenazole ring, pyridine ring, pyrimidine ring and quinoline ring. The heterocyclic group may have substituent, and examples of the substituent groups include the “substituents of the alkyl unit in the substituted alkyl group, substituted alkenyl group, substituted alkynyl group, and substituted aralkyl group”.

Hereinafter, the “compound having a maximum spectroscopic absorption wavelength in solution of 470 nm or less in a wavelength range of 270 to 1,600 nm”, or the “ultraviolet absorbent” will be described.

The maximum spectroscopic absorption wavelength of the compound in solution is preferably 430 nm or less, more preferably 410 nm or less, and still more preferably 380 nm or less, from the viewpoint of spectroscopic absorption characteristics of the compound.

On the other hand, examples of the compounds preferable from the viewpoint of “ultraviolet absorbent” or the spectroscopic absorption characteristics include benzotriazole compounds, benzophenone compounds, cinnamic acid compounds, thiazolidone compounds, 1,3-butadiene compounds, salicylic ester compounds, dianilide oxalate compounds, and the like. Examples of these compounds include those described in Japanese Patent Application Publication (JP-B) No. 44-29627 and JP-A No. 51-56620.

Preferable among them are benzotriazole compounds, benzophenone compounds, cinnamic acid compounds, salicylic ester compounds and dianilide oxalate compounds: more preferable are benzotriazole compounds, benzophenone compounds, cinnamic acid compounds and salicylic ester compounds; still more preferable are benzotriazole compounds, benzophenone compounds and salicylic ester compounds; still more preferable are benzotriazole compounds and benzophenone compounds; and benzotriazole compounds are most preferable. In the invention, at least two of these compounds are used; and preferably, one is a benzotriazole compound, and the other is a compound selected from the benzophenone, cinnamic acid, salicylic ester, and dianilide oxalate compounds.

Compounds preferable as the “compound having a maximum spectroscopic absorption wavelength in solution of 470 nm or less in a wavelength range of 270 to 1,600 nm” or the “ultraviolet absorbent” are represented by the following Formula (I-1) to (I-5).

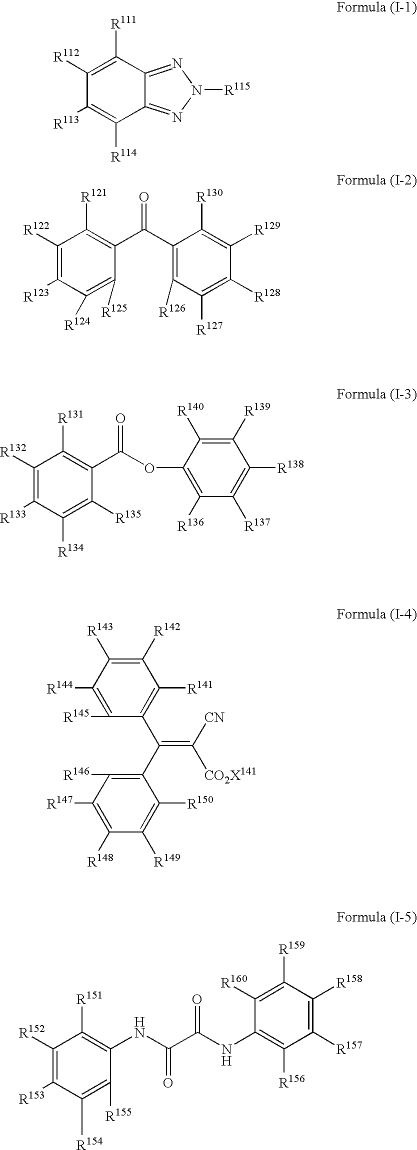

In the Formulae, R¹¹¹ to R¹¹⁴, R¹²¹ to R¹³⁰, R¹³¹ to R¹⁴⁰, R¹⁴¹ to R¹⁵⁰, and R¹⁵¹ to R¹⁶⁰ each independently represent a hydrogen atom or a substituent group; R¹¹⁵ represents a hydrogen atom, an aliphatic group, an aromatic group or a heterocyclic group binding at its carbon atom; and X¹⁴¹ represents a hydrogen atom, an aliphatic group, an aromatic group or a heterocyclic group binding at its carbon atom.

Neighboring groups among benzene ring substituents R¹¹¹ to R¹¹⁴, R¹²¹ to R¹³⁰, R¹³¹ to R¹¹⁴⁰, R¹⁴¹ to R¹⁵⁰, and R¹⁵¹ to R¹⁶⁰ in each Formula may bind to each other, forming a ring.

Examples of the substituent groups represented by R¹¹ to R¹¹⁴, R¹²¹ to R¹³⁰, R¹³¹ to R¹⁴⁰, R¹⁴¹ to R¹⁵⁰, and R¹⁵¹ to R¹⁶⁰ include the “substituents of the alkyl unit in the substituted alkyl group, substituted alkenyl group, substituted alkynyl group, or substituted aralkyl group” described above.

Preferable examples of the R¹¹¹ to R¹¹⁴, R¹²¹ to R¹³⁰, R¹³¹ to R¹⁴⁰, R¹⁴¹ to R¹⁵⁰, and R¹⁵¹ to R¹⁶⁰ include hydrogen and halogen atoms and alkyl, alkenyl, alkynyl, aryl, cyano, hydroxyl, carboxyl, alkoxy, aryloxy, silyloxy, acyloxy, carbamoyloxy, alkoxycarbonyloxy, aryloxycarbonyloxy, amino, acylamino, aminocarbonylamino, alkoxycarbonylamino, aryloxycarbonylamino, sulfamoylamino, alkyl or arylsulfonylamino, mercapto, alkylthio, arylthio, sulfamoyl, sulfo, alkyl- or aryl-sulfinyl, alkyl- or aryl-sulfonyl, acyl, aryloxycarbonyl, alkoxycarbonyl, carbamoyl, imido, phosphino, phosphinyl, phosphinyloxy, phosphinylamino, and silyl groups.

More preferably, each of R¹¹¹ to R¹¹⁴ represents a hydrogen or halogen atom or an alkyl, alkenyl, aryl, cyano, hydroxyl, carboxyl, alkoxy, aryloxy, silyloxy, amino, alkylthio, arylthio, imido, or silyl group; more preferably a hydrogen or halogen atom or an alkyl, aryl, alkoxy, aryloxy, silyloxy, or amino group; and still more preferably a hydrogen or halogen atom or an alkyl; and most preferably a hydrogen or halogen atom.

More preferably, each of R¹²¹ to R¹³⁰ represents a hydrogen or halogen atom or an alkyl, alkenyl, aryl group, cyano, hydroxyl, carboxyl, alkoxy, aryloxy, silyloxy, acyloxy, acylamino, aminocarbonylamino, alkoxycarbonylamino, aryloxycarbonylamino, sulfamoylamino, alkyl or arylsulfonylamino, mercapto, alkylthio, arylthio, sulfamoyl, sulfo, alkyl- or aryl-sulfonyl, acyl, aryloxycarbonyl, alkoxycarbonyl, carbamoyl, imide, or silyl group; more preferably a hydrogen or halogen atom or an alkyl, aryl, hydroxyl, alkoxy, aryloxy, acyloxy, acylamino, alkyl- or aryl-sulfonylamino, sulfamoyl, acyl, aryloxycarbonyl, alkoxycarbonyl, or carbamoyl group; still more preferably a hydrogen or halogen atom or an alkyl, hydroxyl, alkoxy, acyloxy, acylamino, acyl, alkoxycarbonyl, or carbamoyl group; and still more preferably a hydrogen or halogen atom or an alkyl, hydroxyl, alkoxy, acylamino, or alkoxycarbonyl group. R¹²¹ most preferably represents a hydroxy group.

More preferably, each of R¹³¹ to R¹⁴⁰ represents a hydrogen or halogen atom or an alkyl, alkenyl, aryl, cyano, hydroxyl, carboxyl, alkoxy, aryloxy, silyloxy, acyloxy, acylamino, aminocarbonylamino, alkoxycarbonylamino, aryloxycarbonylamino, sulfamoylamino, alkyl- or aryl-sulfonylamino, mercapto, alkylthio, arylthio, sulfamoyl, sulfo, alkyl- or aryl-sulfonyl, acyl, aryloxycarbonyl, alkoxycarbonyl, carbamoyl, imide, or silyl group;

more preferably a hydrogen or halogen atom or an alkyl, aryl, hydroxyl, alkoxy, aryloxy, acyloxy, acylamino, alkyl- or aryl-sulfonylamino, sulfamoyl, acyl, aryloxycarbonyl, alkoxycarbonyl, or carbamoyl group; still more preferably a hydrogen or halogen atom or an alkyl, hydroxyl, alkoxy, acyloxy, acylamino, acyl, alkoxycarbonyl, or carbamoyl group; and still more preferably a hydrogen or halogen atom or an alkyl, hydroxyl, alkoxy, acylamino, or alkoxycarbonyl group. R¹³¹ most preferably represents a hydroxy group.

More preferably, each of R¹⁴¹ to R¹⁵⁰ represents a hydrogen or halogen atom or an alkyl, aryl, hydroxyl, alkoxy, aryloxy, silyloxy, acyloxy, carbamoyloxy, alkoxycarbonyloxy, aryloxycarbonyloxy, amino, acylamino, aminocarbonylamino, alkoxycarbonylamino, aryloxycarbonylamino, sulfamoylamino, alkyl- or aryl-sulfonylamino, alkylthio, arylthio, sulfamoyl, acyl, aryloxycarbonyl, alkoxycarbonyl, carbamoyl, or silyl group; more preferably a hydrogen or halogen atom or an alkyl, aryl, alkoxy, aryloxy, amino, acylamino, alkylthio, or arylthio group; still more preferably a hydrogen or halogen atom or an alkyl, alkoxy, amino, or acylamino group; and most preferably a hydrogen atom or an alkoxy or amino group.

More preferably, each of R¹⁵¹ to R¹⁶⁰ represents a hydrogen or halogen atom or alkyl, aryl, cyano, hydroxyl, alkoxy, aryloxy, acyloxy, amino, acylamino, mercapto, alkylthio, arylthio, sulfamoyl, alkyl- or aryl-sulfinyl, alkyl- or aryl-sulfonyl, acyl, aryloxycarbonyl, alkoxycarbonyl, or silyl group; and more preferably a hydrogen or halogen atom or an alkyl, aryl, hydroxyl, alkoxy, acyloxy, amino, acylamino, arylthio, acyl, aryloxycarbonyl, or alkoxycarbonyl group.

R¹¹⁵ represents a hydrogen atom or an aliphatic, aromatic or heterocyclic group binding at its carbon atom; preferably a hydrogen atom or an alkyl, alkenyl, alkynyl, or aryl group; more preferably a hydrogen atom or an alkyl group having 1 to 30 carbon atoms, an alkenyl group having 2 to 30 carbon atoms, an alkynyl group having 2 to 30 carbon atoms, or an aryl group having 6 to 30 carbon atoms; still more preferably a hydrogen atom or an alkyl group having 1 to 25 carbon atoms, an alkenyl group having 2 to 25 carbon atoms, or an aryl group having 6 to 25 carbon atoms; still more preferably an carbon alkyl group having 1 to 22 carbon atoms or an aryl group having 6 to 22 carbon atoms; still more preferably an aryl group having 6 to 20 carbon atoms; and most preferably an ortho-hydroxyphenyl group having 6 to 20 carbon atoms.

X¹⁴¹ represents a hydrogen atom, an aliphatic, an aromatic group or a heterocyclic group binding at its carbon atom; preferably a hydrogen atom or an alkyl, alkenyl, alkynyl, or aryl group; more preferably a hydrogen atom, an alkyl group having 1 to 30 carbon atoms, an alkenyl group having 2 to 30 carbon atoms, an alkynyl group having 2 to 30 carbon atoms, an aryl group having 6 to 30 carbon atoms; more preferably a hydrogen atom, an alkyl group having 1 to 25 carbon atoms, an alkenyl group having 2 to 25 carbon atoms, or an aryl group having 6 to 25 carbon atoms; still more preferably an alkyl group having 1 to 22 carbon atoms or an aryl group having 6 to 22 carbon atoms; and most preferably an alkyl group having 1 to 18 carbon atoms.

Preferably among these compounds, at least two compounds represented by the Formulae above are selected, and more preferably, at least two compounds respectively represented by different Formulae (I-1) to (I-5) are selected.

Preferably, at least one is a compound represented by Formula (I-1) or a compound represented by one of the Formulae (I-2) to (I-5), and more preferably, at least one is a compound represented by Formula (I-1).

Hereinafter, specific examples of the “compounds having a maximum spectroscopic absorption wavelength in solution of 470 nm or less in a wavelength range of 270 to 1,600 nm” or the “ultraviolet absorbents” are listed below, however the invention is not limited thereto.

(Compounds included in Formula (I-1))

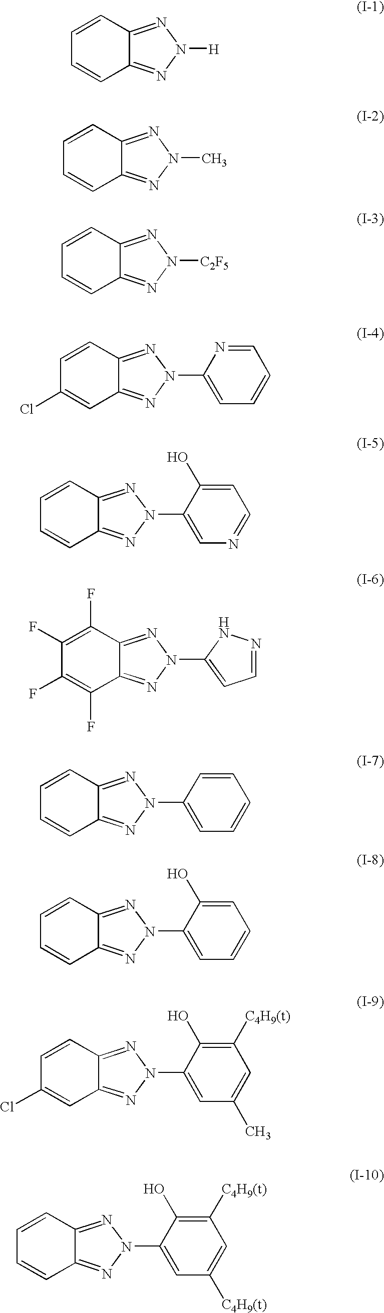

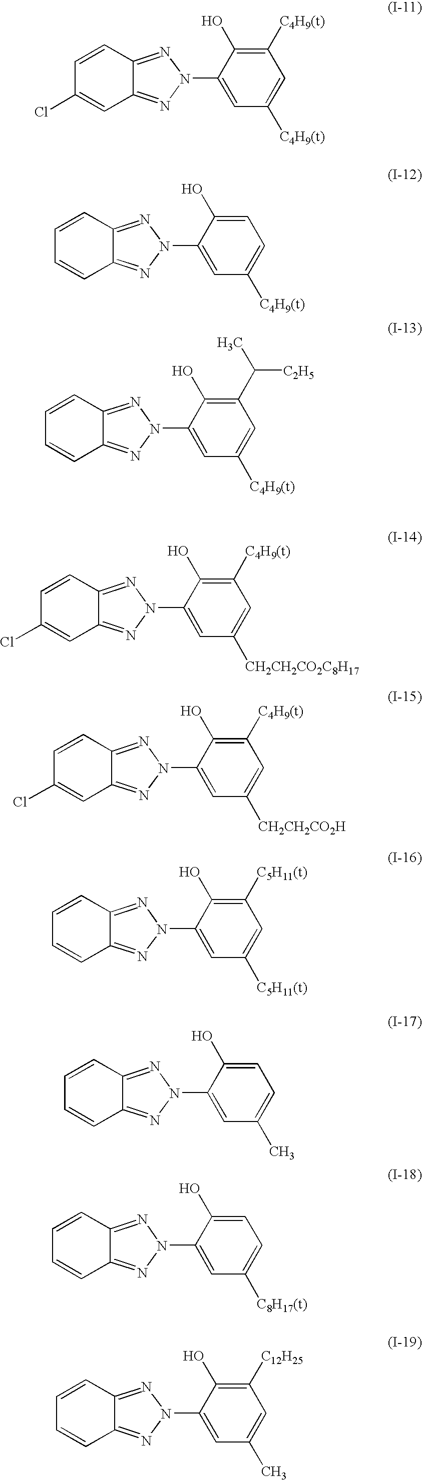

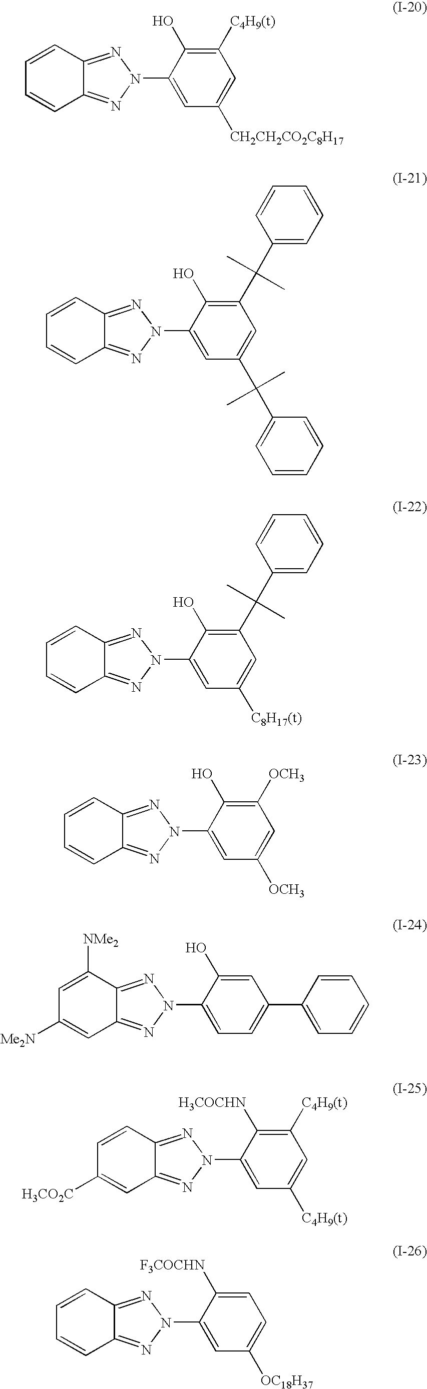

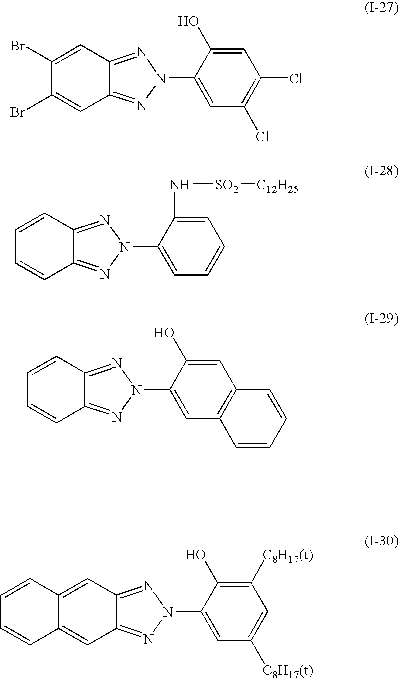

(Compounds included in Formula (I-2))

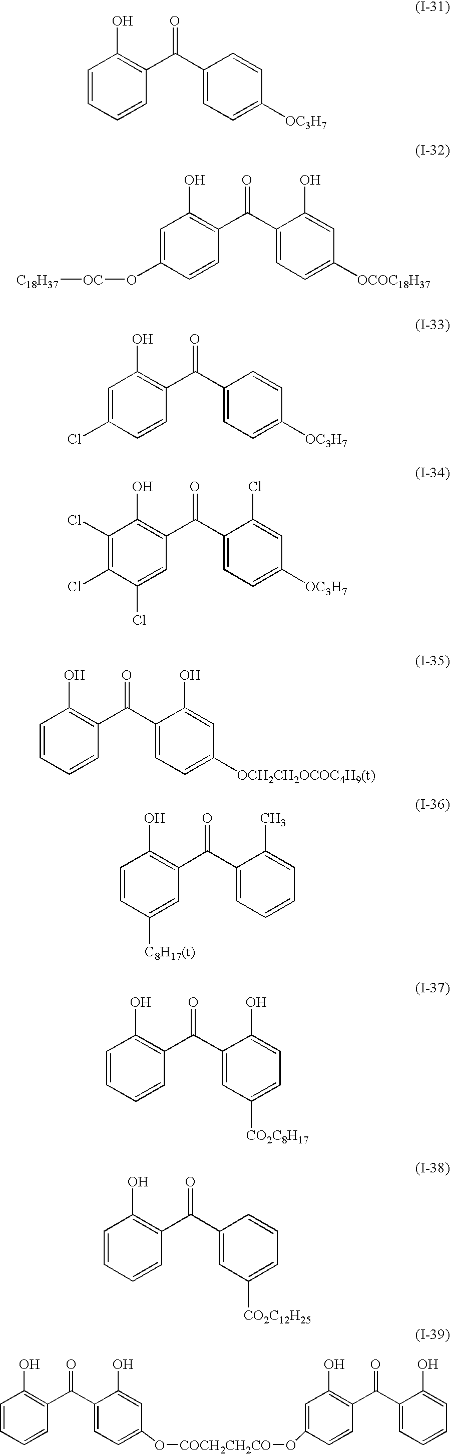

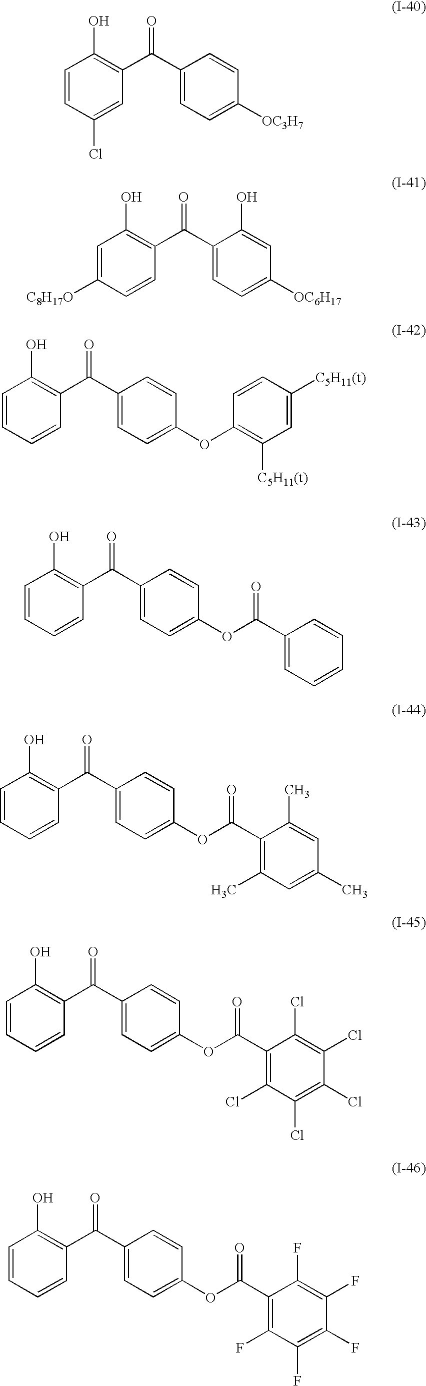

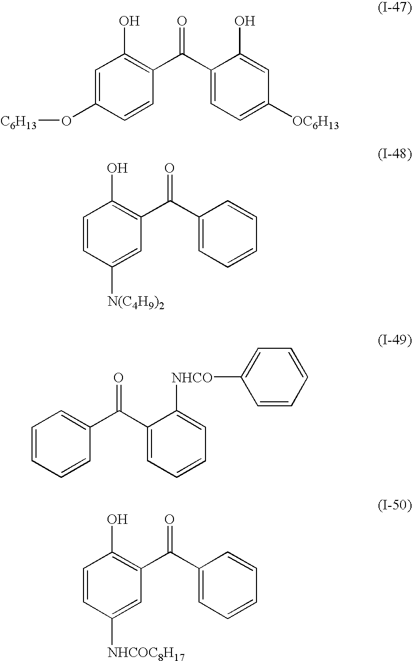

(Compounds included in Formula (I-3))

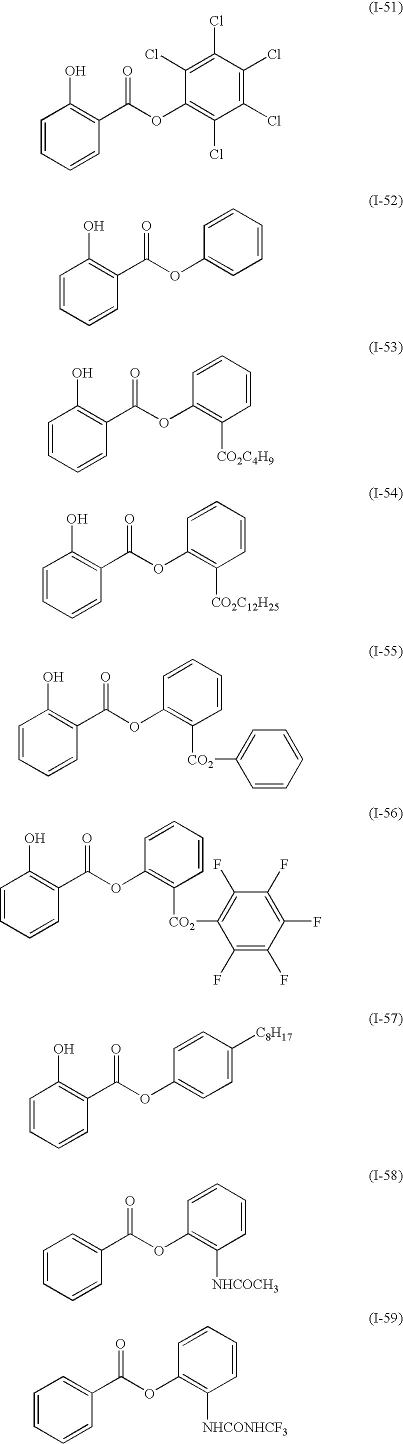

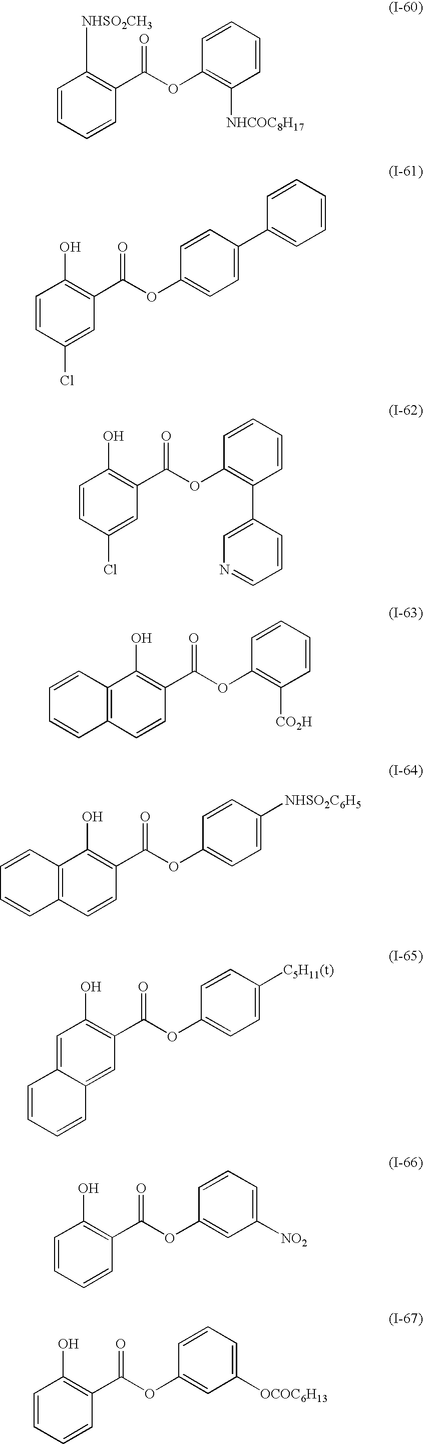

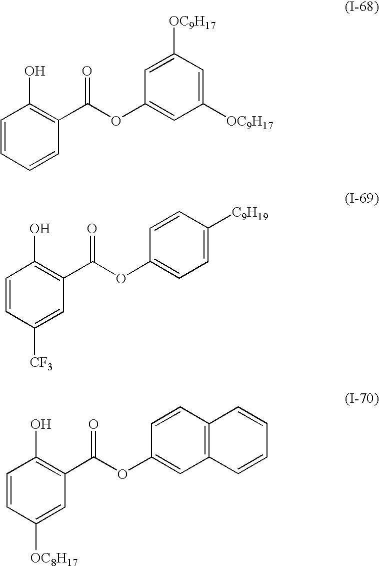

(Compounds included in Formula (I-4))

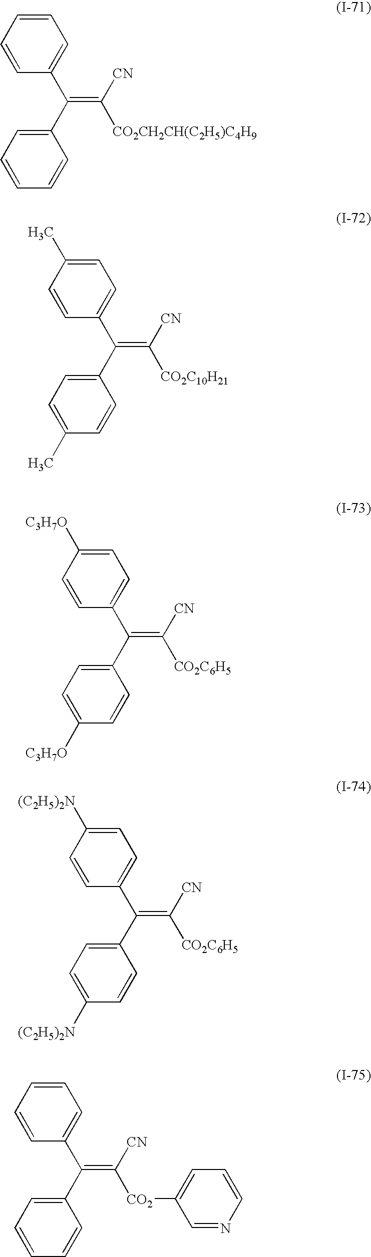

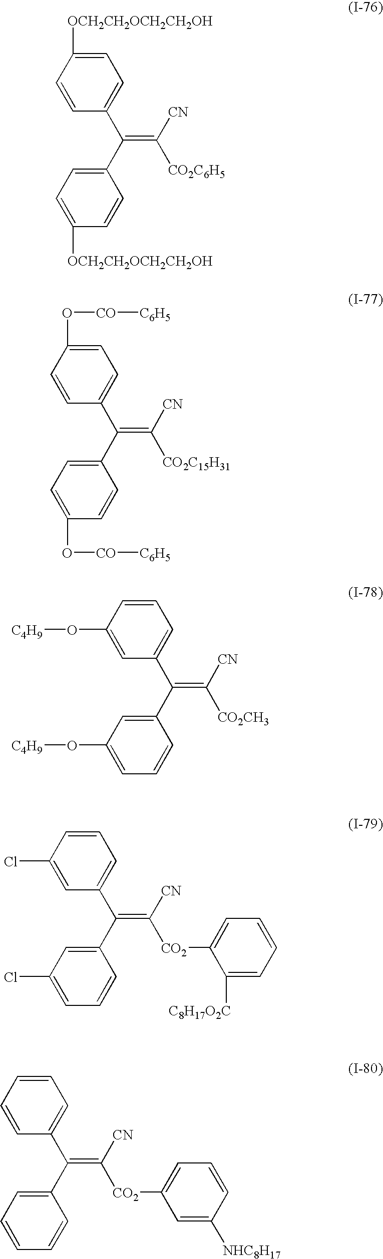

(Compounds included in Formula (I-5))

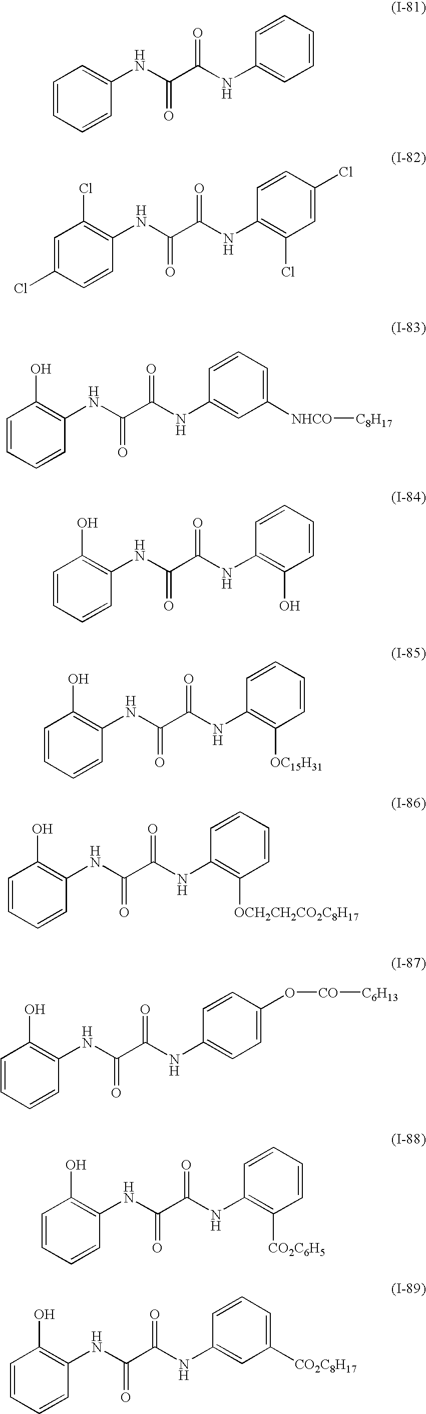

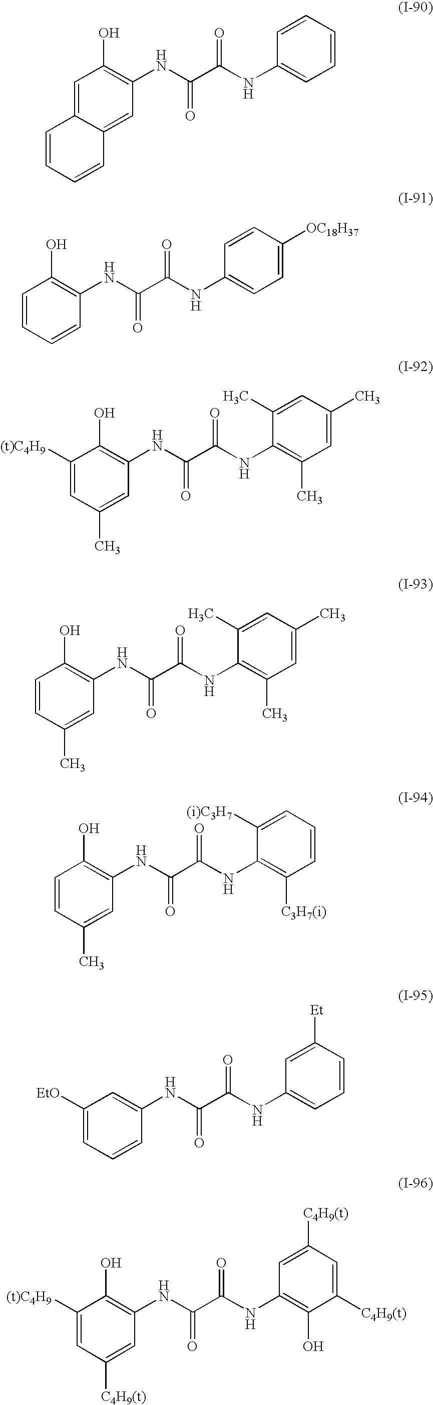

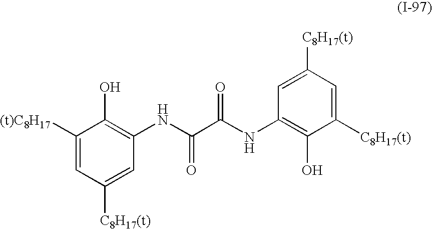

These compounds can be synthesized easily according to the methods described in JP-B No. 50-25337, U.S. Pat. No. 3,785,827, JP-A No. 5-4449, JP-B No. 48-30492, or Journal of Organic Chemistry, vol. 23, p. 1344 (1958) or methods similar to those. The compounds represented by Formula (I-1) are commercially available, for example, under the trade name of “Tinuvin 109” of Ciba Specialty Chemicals.

Hereinafter, the “compound having a maximum spectroscopic absorption wavelength in solution of 700 nm or more in a wavelength range of 400 to 1,600” defined in “at least one near-infrared absorbent or infrared absorbent” or the “near-infrared or infrared absorbent” will be described.

These compounds preferably have a maximum spectroscopic absorption wavelength of 730 nm or more, more preferably 760 nm or more and still more preferably 780 nm or more, from the viewpoint of spectroscopic absorption characteristics.

On the other hand, examples of the “near-infrared or infrared absorbents” or the compounds having the spectroscopic absorption characteristics above include phthalocyanine compounds, cyanine compounds, squarylium compounds, diimmonium compounds, polymethine compounds, azomethine compounds, oxonol compounds, chroconium compounds and dithiol metal complex compounds. Specific examples thereof include those described in JP-A Nos. 2000-281919, 10-180947, and 2003-139946.

Preferable among them are phthalocyanine compounds, cyanine compounds, squarylium compounds, diimmonium compounds, polymethine compounds, oxonol compounds and chroconium compounds; more preferable are phthalocyanine compounds, cyanine compounds, diimmonium compounds, oxonol compounds and chroconium compounds; still more preferable are phthalocyanine compounds, diimmonium compounds, oxonol compounds and chroconium compounds; still more preferable are phthalocyanine compounds, diimmonium compounds and oxonol compounds; and most preferable are phthalocyanine compounds.

Preferable compounds among these are represented by the following Formula (II-1):

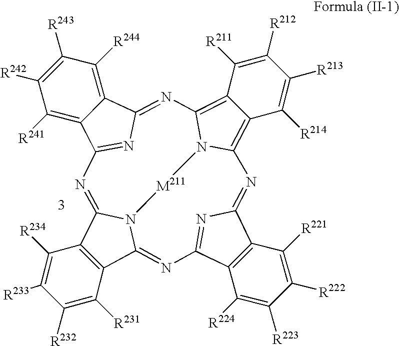

In the Formula, R²¹¹ to R²⁴⁴ each independently represent a hydrogen atom or a substituent group, and neighboring groups in R²¹¹ to R²⁴⁴, substituents on the benzene ring, may bind to each other to form a ring. M²¹¹ represent two atoms selected from the group consisting of a hydrogen atom and monovalent metal atoms, a divalent atom, or a divalent substituted metal atom including a trivalent or quadrivalent metal atom.

Examples of the substituent groups on R²¹¹ to R²⁴⁴ include the substituent groups on the alkyl unit of the substituted alkyl, substituted alkenyl, substituted alkynyl and substituted aralkyl groups described above. Preferable examples thereof include halogen atoms and alkyl, alkenyl, alkynyl, aryl, cyano, hydroxyl, nitro, carboxyl, alkoxy, aryloxy, silyloxy, heterocyclic oxy, acyloxy, carbamoyloxy, alkoxycarbonyloxy, aryloxycarbonyloxy, amino, acylamino, aminocarbonylamino, alkoxycarbonylamino, aryloxycarbonylamino, sulfamoylamino, alkyl- or aryl-sulfonylamino, mercapto, alkylthio, arylthio, heterocyclic thio, sulfamoyl, sulfo, alkyl- or aryl-sulfinyl, alkyl- or aryl-sulfonyl, acyl, aryloxycarbonyl, alkoxycarbonyl, carbamoyl, imide, phosphino, phosphinyl, phosphinyloxy, phosphinylamino, and silyl groups; more preferably halogen atoms and alkyl, aryl, cyano, hydroxyl, nitro, carboxyl, alkoxy, aryloxy, silyloxy, heterocyclic oxy, acyloxy, carbamoyloxy, amino, acylamino, aminocarbonylamino, alkoxycarbonylamino, aryloxycarbonylamino, sulfamoylamino, alkyl- or aryl-sulfonylamino, mercapto, alkylthio, arylthio, heterocyclic thio, sulfamoyl, sulfo, alkyl- or aryl-sulfinyl, alkyl- or aryl-sulfonyl, carbamoyl, imide, phosphino, phosphinyl, phosphinyloxy, phosphinylamino, and silyl groups; still more preferably halogen atoms and alkyl, aryl, hydroxyl, alkoxy, aryloxy, amino, mercapto, alkylthio, arylthio, sulfamoyl, sulfo, alkyl- or aryl-sulfinyl, and alkyl- or aryl-sulfonyl groups; still more preferably halogen atoms and alkyl, aryl, alkoxy, aryloxy, alkylthio, and arylthio groups, still more preferably halogen atoms, alkyl groups having 1 to 20 carbon atoms, aryl groups having 6 to 20 carbon atoms, alkoxy groups having 1 to 20 carbon atoms, aryloxy groups having 6 to 20 carbon atoms, alkylthio groups having 1 to 20 carbon atoms, and arylthio groups having 6 to 20 carbon atoms; still more preferably alkyl groups having 1 to 8 carbon atoms, aryl groups having 6 to 10 carbon atoms, alkoxy groups having 1 to 8 carbon atoms, aryloxy groups having 6 to 10 carbon atoms, alkylthio groups having 1 to 8 carbon atoms, and arylthio groups having 6 to 10 carbon atoms; still more preferably alkoxy groups having 1 to 6 carbon atoms, aryloxy groups having 6 to 8 carbon atoms, alkylthio groups having 1 to 6 carbon atoms, and arylthio groups having 6 to 8 carbon atoms; and most preferably alkoxy groups having 1 to 4 carbon atoms.

R²¹² and R²¹³, R²²² and R²²³R²³² and R²³³, or R²⁴² and R²⁴³ may bind to each other to form a fused condensation benzene ring.

Preferable examples of M²¹¹ include two hydrogen atoms, two Li⁺ ions, two Na⁺ ions, two K⁺ ions, two Rb⁺ ions, two Cs⁺ ions, Be²⁺, Mn²⁺, Cae²⁺, Ti²⁺, Mn²⁺, Fe²⁺, Co₂₊, Ni²⁺, Cu²⁺, Zn²⁺, Ru²⁺, Rh²⁺, Pd²⁺, Pt²⁺, Ba²⁺, Cd²⁺, Cd²⁺, Hg²⁺, Pb²⁺, Xn²⁺, Al—Cl, Al—Br, Al—F, Al—I, Ga—Cl, Ga—F Ga—I, Ga—Br, In—Cl, In—Br, In—I, In—F, TI—Cl, TI—Br, TI—I, TI—F, Mn—OH, Fe—Cl, Ru—Cl, CrCl₂, SiCl₂, SiBr₂, SiF₂, SiI₂, ZrCl₂, GeCl₂, GeBr₂, GeI₂, GeF₂, SnCl₂, SnBr₂, SnI₂, SnF₂, TiCl₂, TiBr₂, TiF₂, Si(OH)₂, Ge(OH)₂, Zr(OH)₂, Mn(OH)₂, Sn(OH)₂, TiR₂, GrR₂, SiR₂, SnR₂, GeR₂, Si(OR)₂, Sn(OR)₂, Ge(OR)₂, Ti(OR)₂, Cr(OR)₂, Sn(SR)₂, Ge(SR)₂ [R represents an aliphatic or aromatic group], VO, MnO, and TiO; preferable are two hydrogen atoms, two Li⁺, two Na⁺, two K⁺, two Rb⁺ and Be²⁺, Mg²⁺, Ca²⁺, Ti²⁺, Mn²⁺, Fe²⁺, Co₂₊, Ni²⁺, Cu²⁺, Zn²⁺, Ru²⁺, Rh²⁺, Pd²⁺, Pt²⁺, Ba²⁺, Sn²⁺, Al—Cl, Al—Br, Ga—Cl, Ga—F, Ga—I, Ga—Br, In—Cl, In—Br, TI—Cl, TI—Br, Mn—OH, Fe—Cl, Ru—Cl, CrCl₂, SiCl₂, SiBr₂, ZrCI₂, GeCl₂, GeBr₂, SnCl₂, SnBr₂, TiCl₂, TiBr₂, Si(OH)₂, Ge(OH)₂, Zr(OH)₂, Mn(OH)₂, Sn(OH)₂, TiR₂, GrR₂, SiR₂, SnR₂, GeR₂, Si(OR)₂, Sn(OR)₂, Ge (OR)₂, Ti(OR)₂, Cr(OR)₂, Sn(SR)₂, Ge(SR)₂ [R represents an aliphatic or aromatic group], VO, MnO, TiO; still preferable are two hydrogen atoms, two Li⁺, two Na⁺, two K⁺, and Be²⁺, Mg²⁺, Ca²⁺, Ti²⁺, Mn²⁺, Fe²⁺, CO₂₊, Ni²⁺, Cu²⁺, Zn²⁺, Ru²⁺, Rh²⁺, Pd²⁺, Pt²⁺, Ba²⁺, Sn²⁺, Al—Cl, Ga—Cl, In—Cl, Tl—Cl, Mn—OH, Fe—Cl, Ru—Cl, CrCl₂, SiCl₂, ZrCl₂, GeCl₂, TiCl₂, Si (OH)₂, Ge (OH)₂, Zr(OH)₂, Mn(OH)₂, TiR₂, CrR₂, SiR₂, GeR₂, Si(OR)₂, Ge(OR)₂, Ti(OR)₂, Cr(OR)₂ [R represents an aliphatic or aromatic group], VO, MnO, and TiO; still more preferable M¹'s are two hydrogen atoms, Mn²⁺, VO, Zn²⁺ or Cu²⁺; and most preferable are VO, Zn²⁺ and Cu²⁺.

Hereinafter, specific examples of the “near-infrared or infrared absorbents” or the compounds satisfying the requirements in spectroscopic absorption characteristics for use in the invention are listed below, however the invention is not limited thereto.

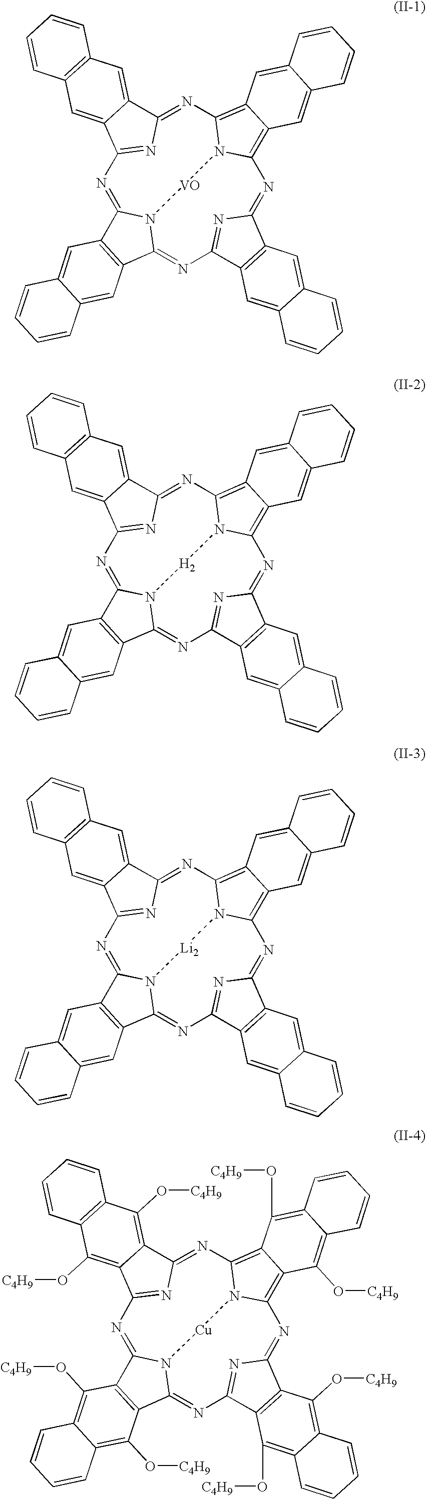

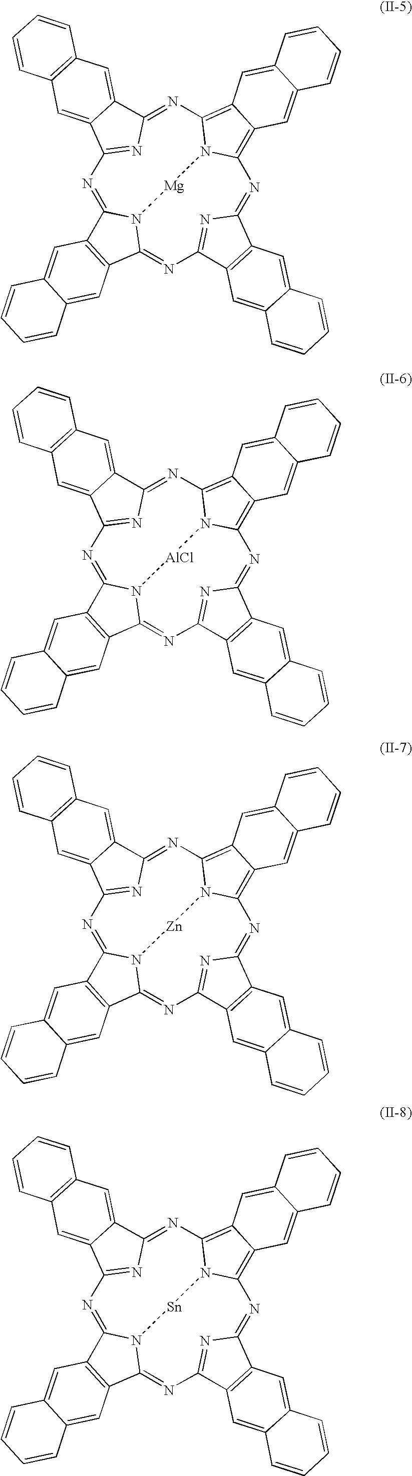

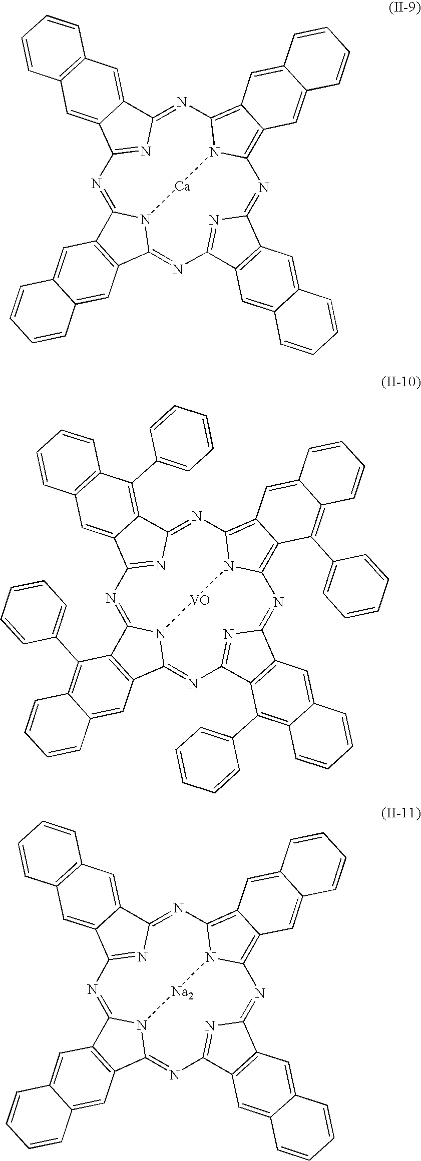

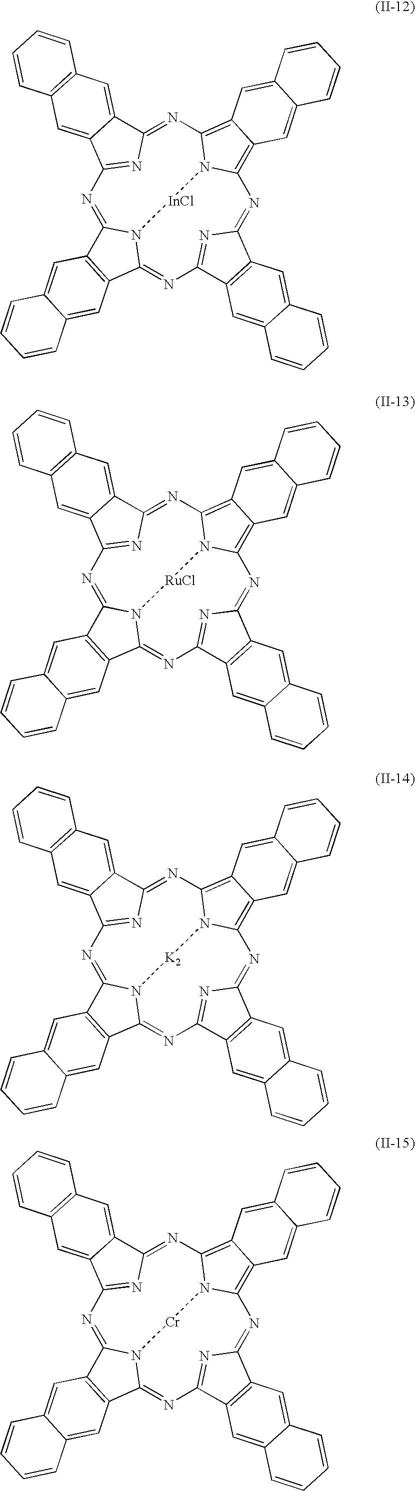

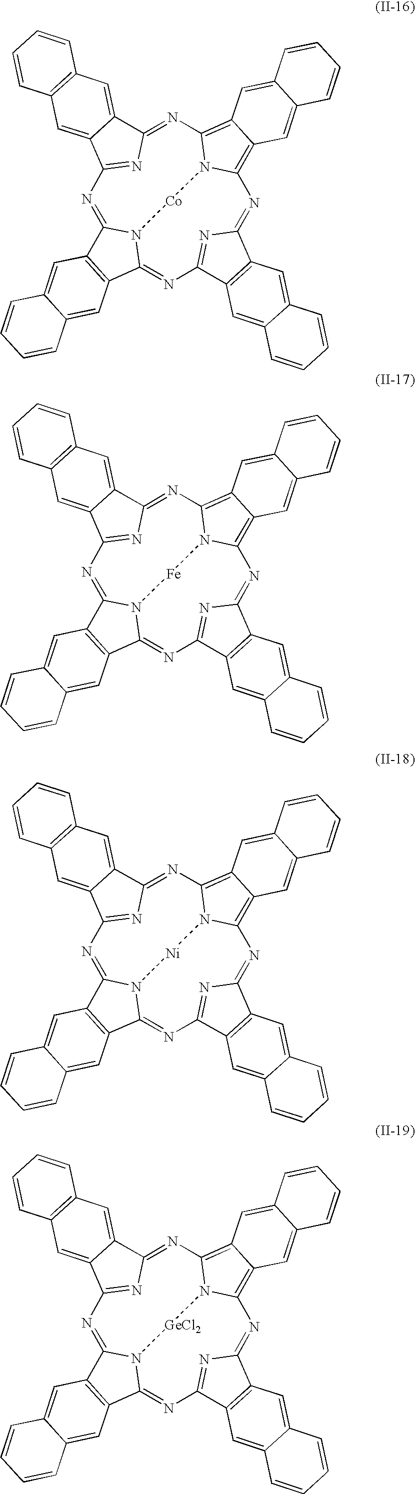

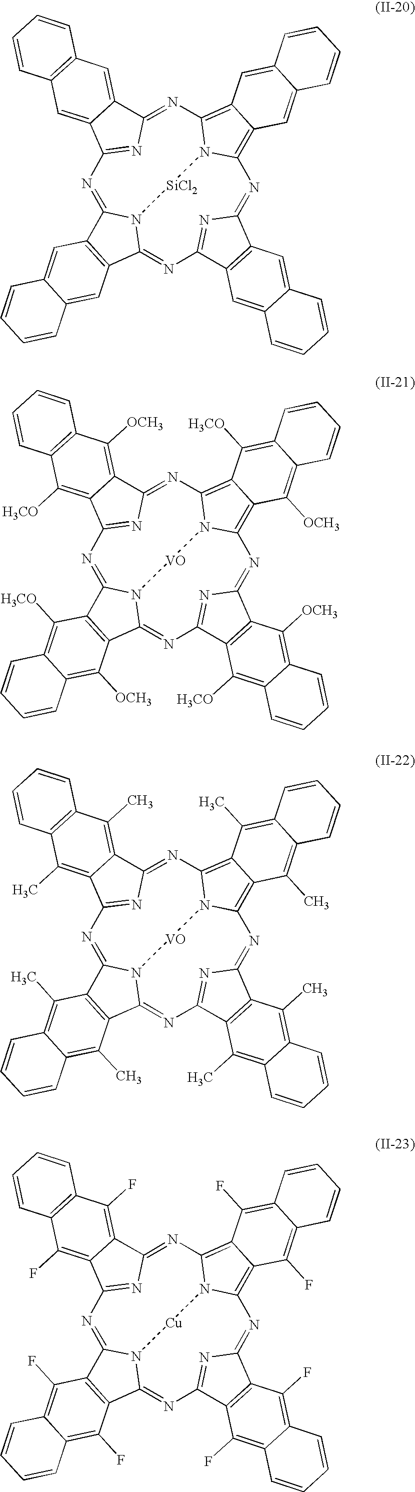

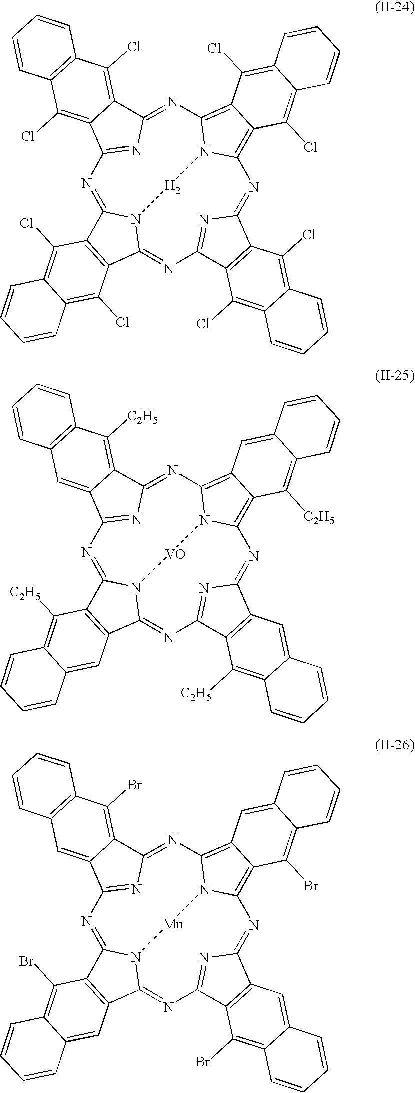

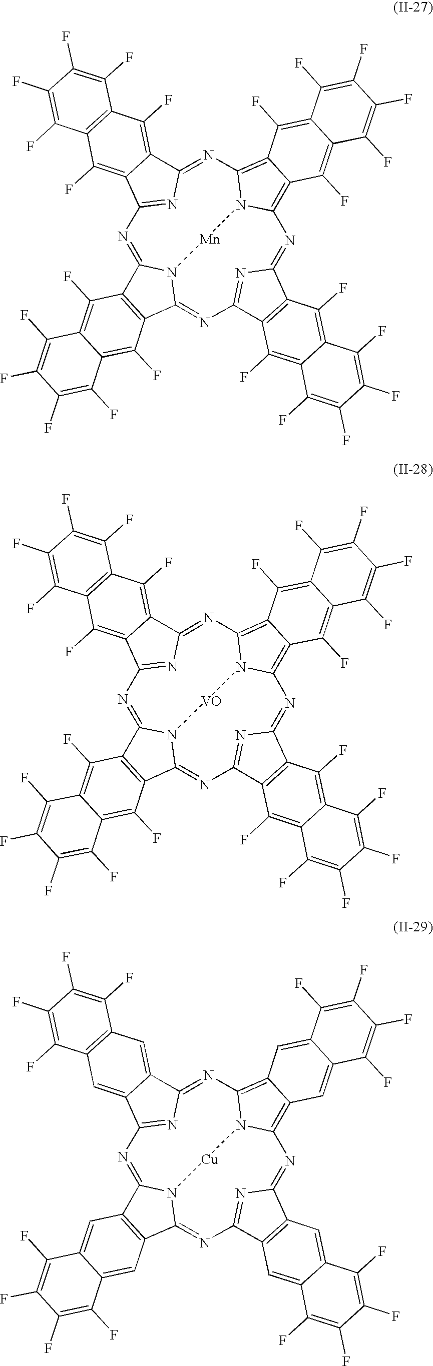

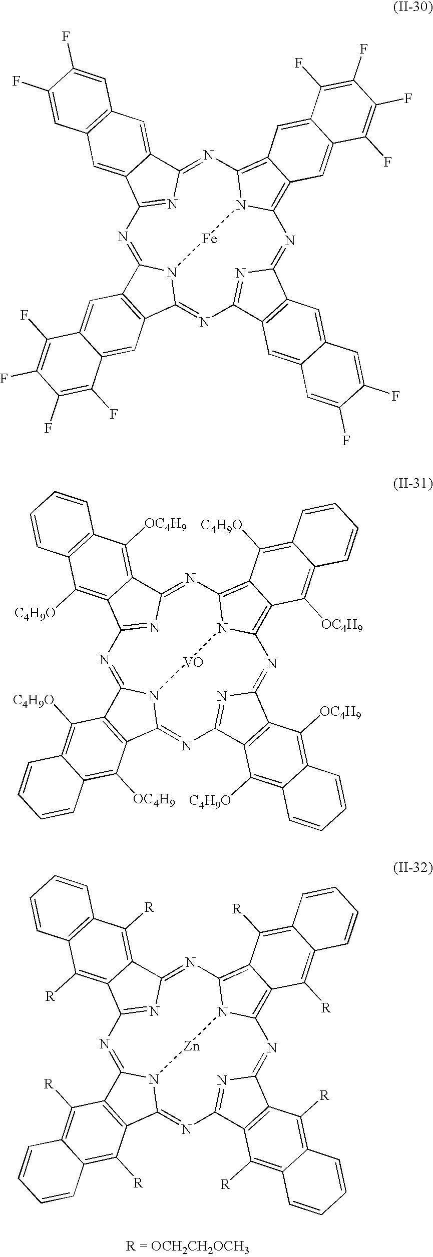

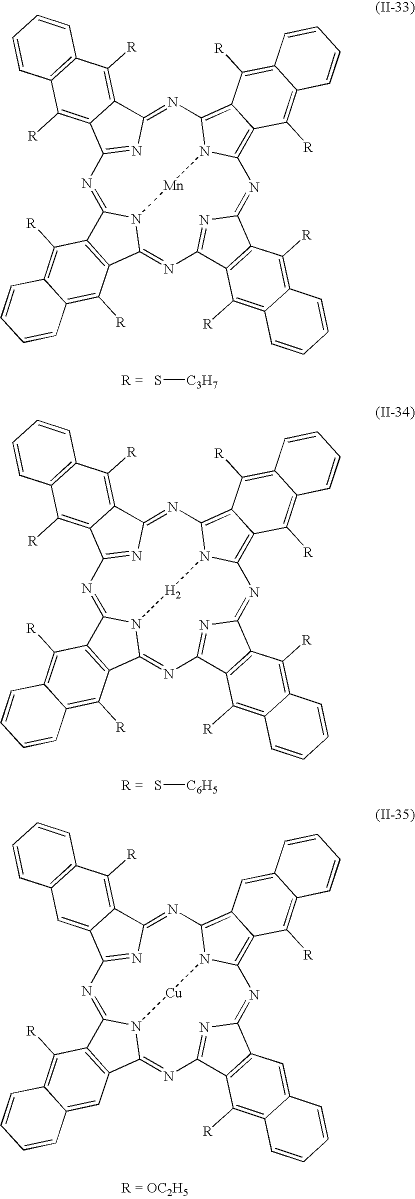

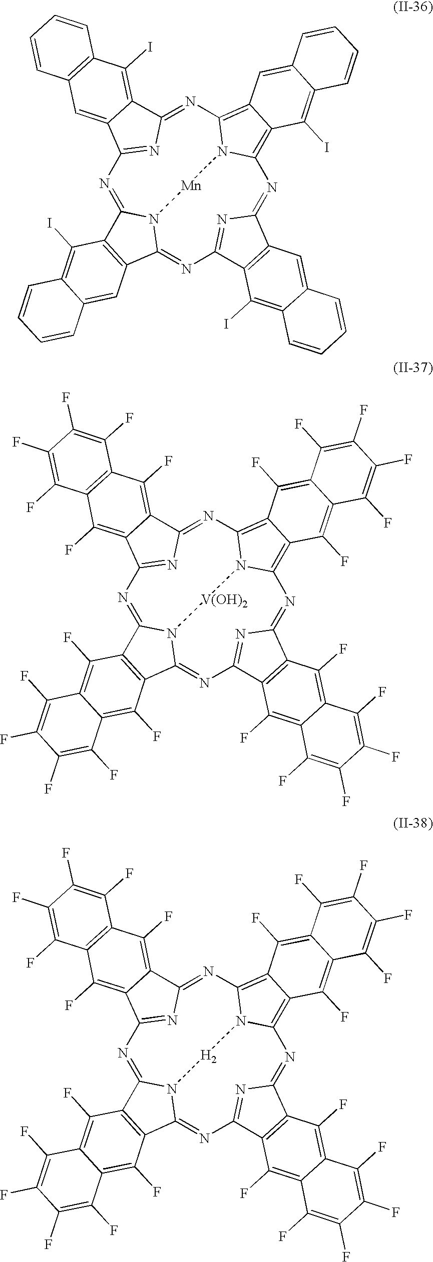

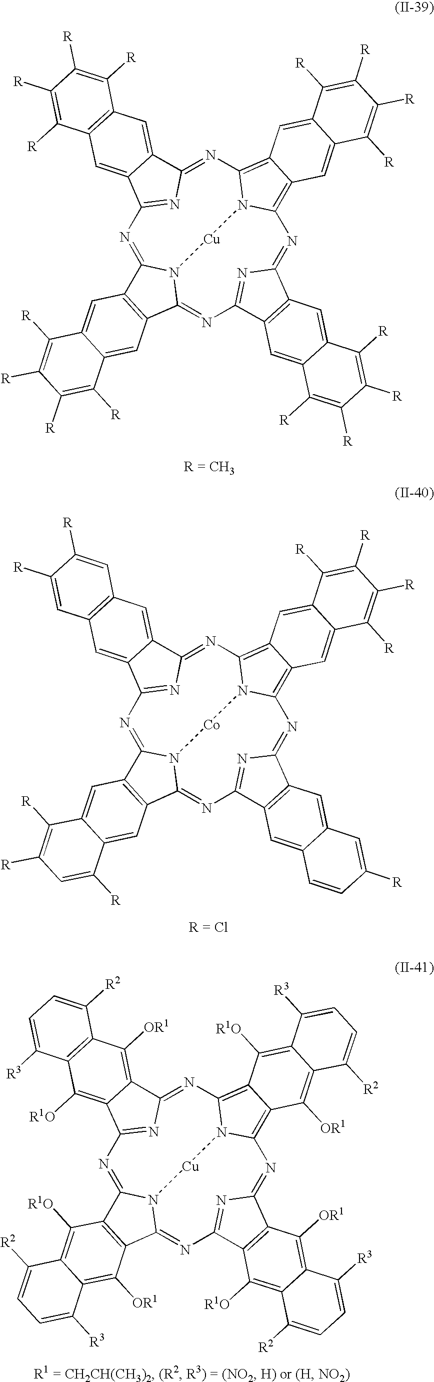

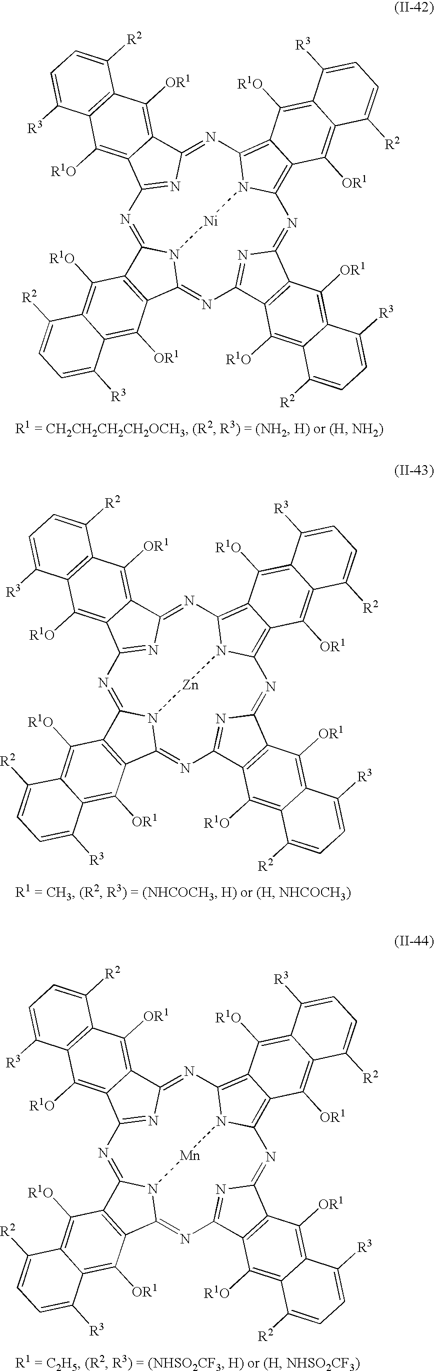

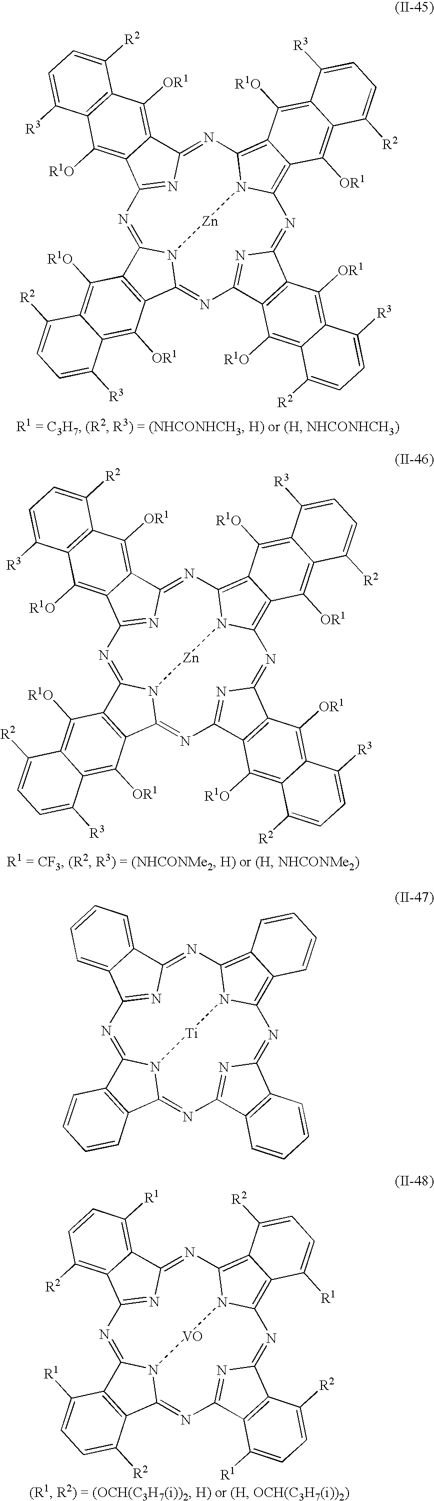

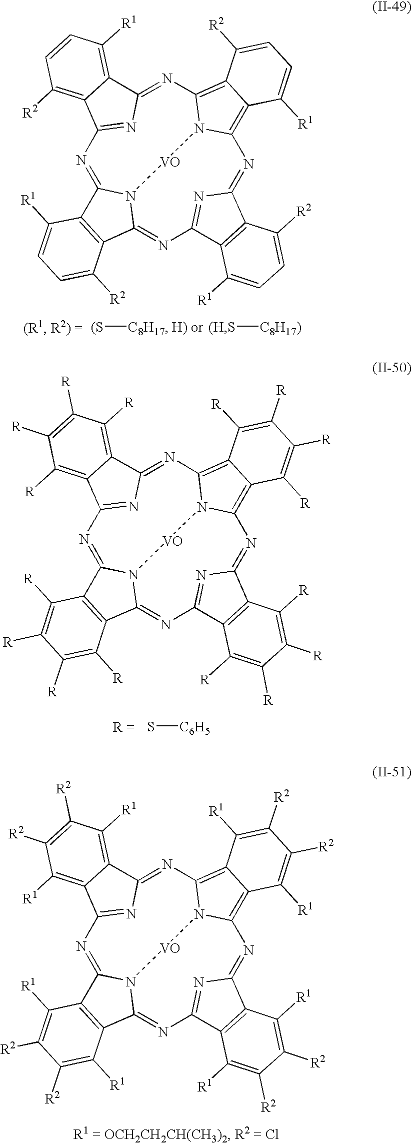

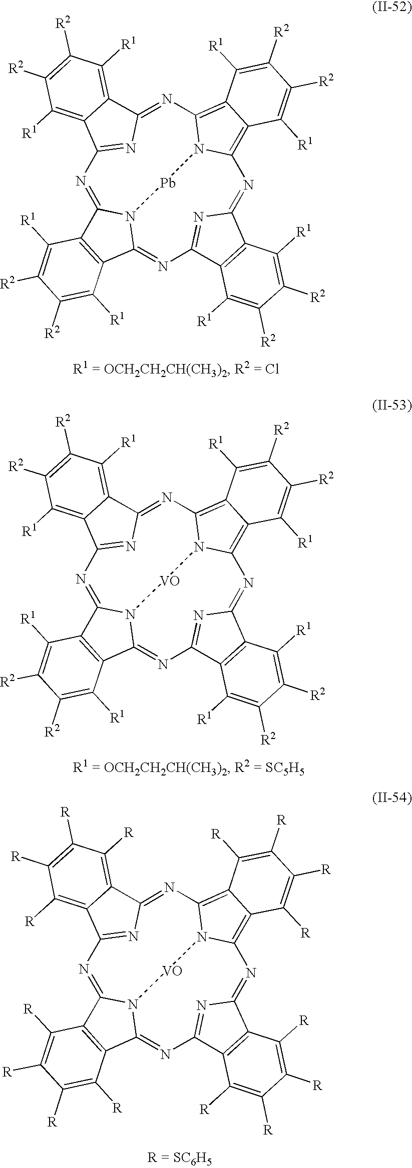

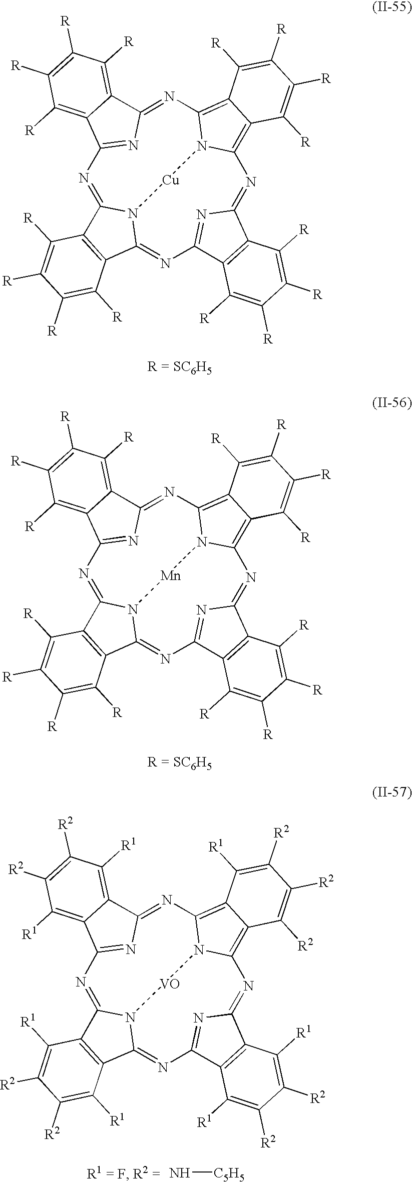

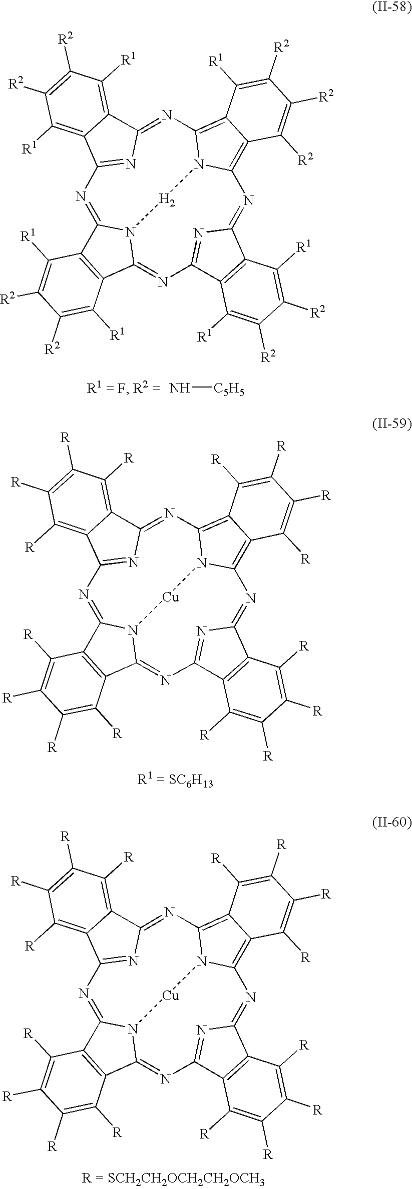

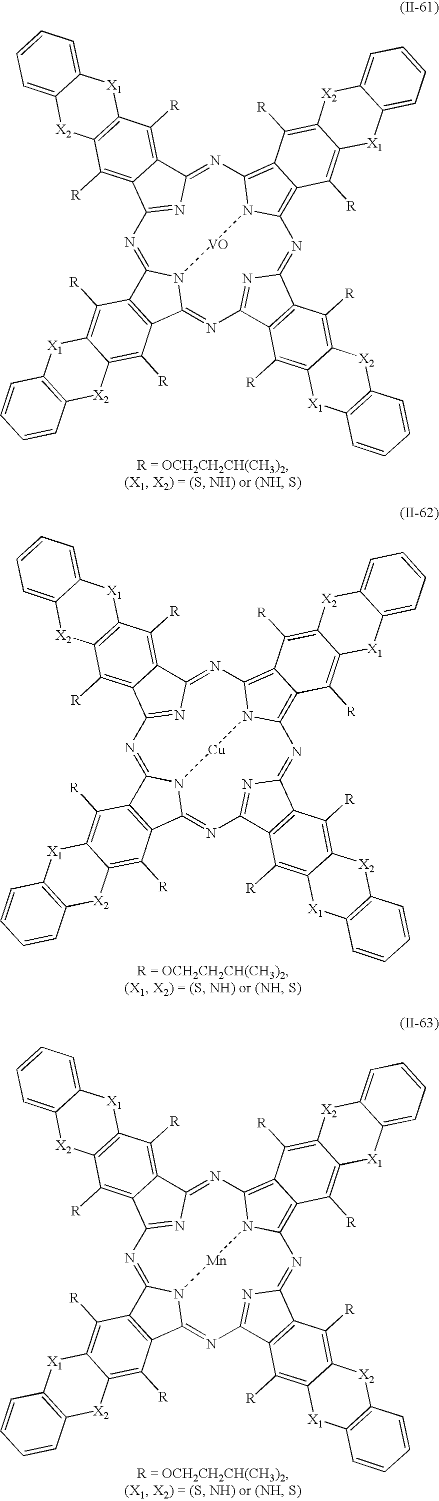

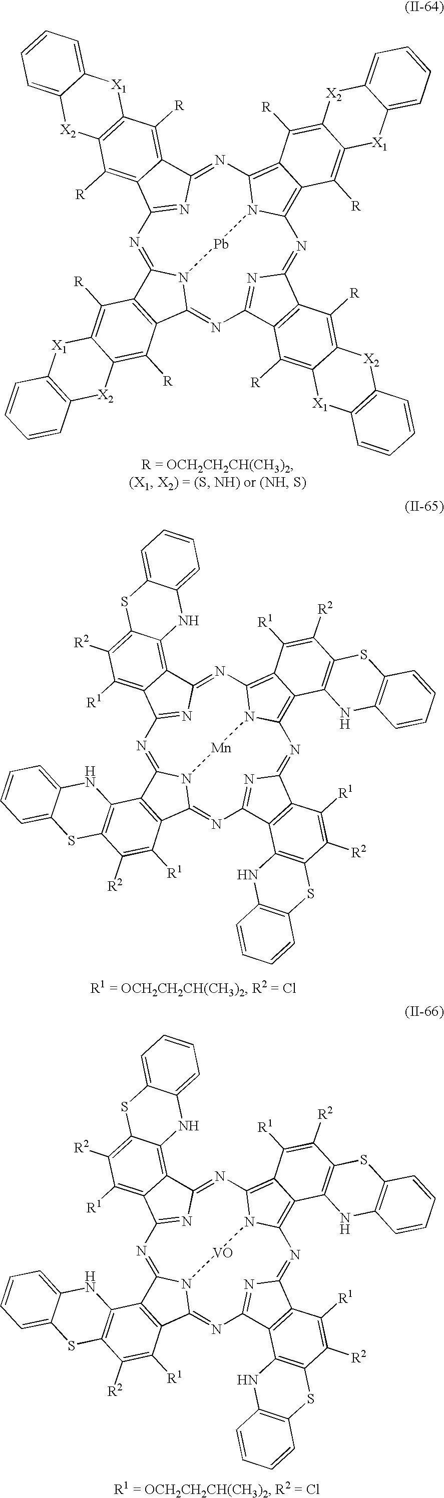

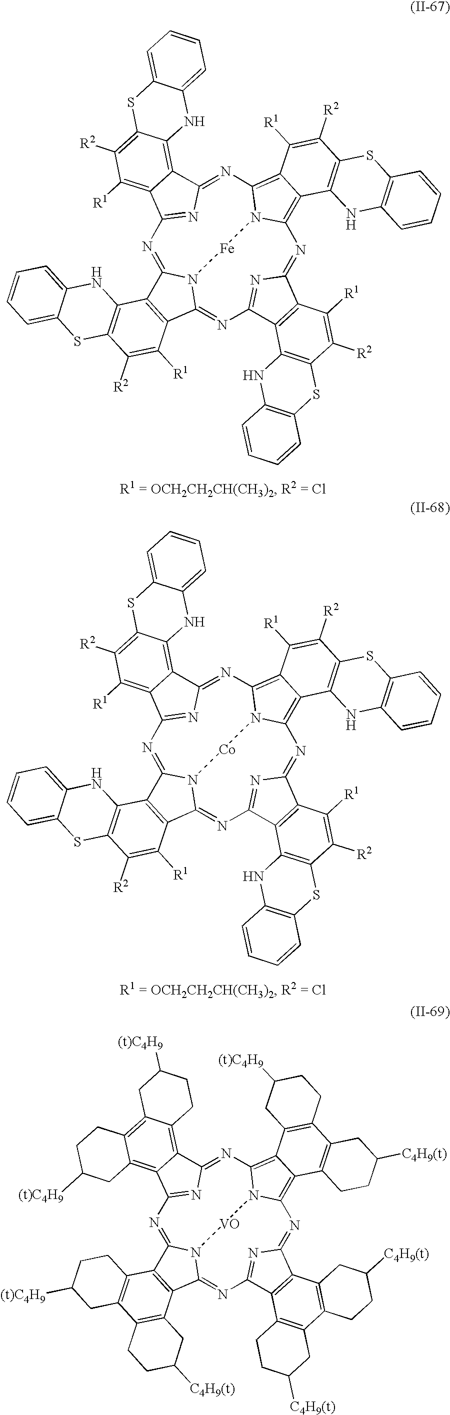

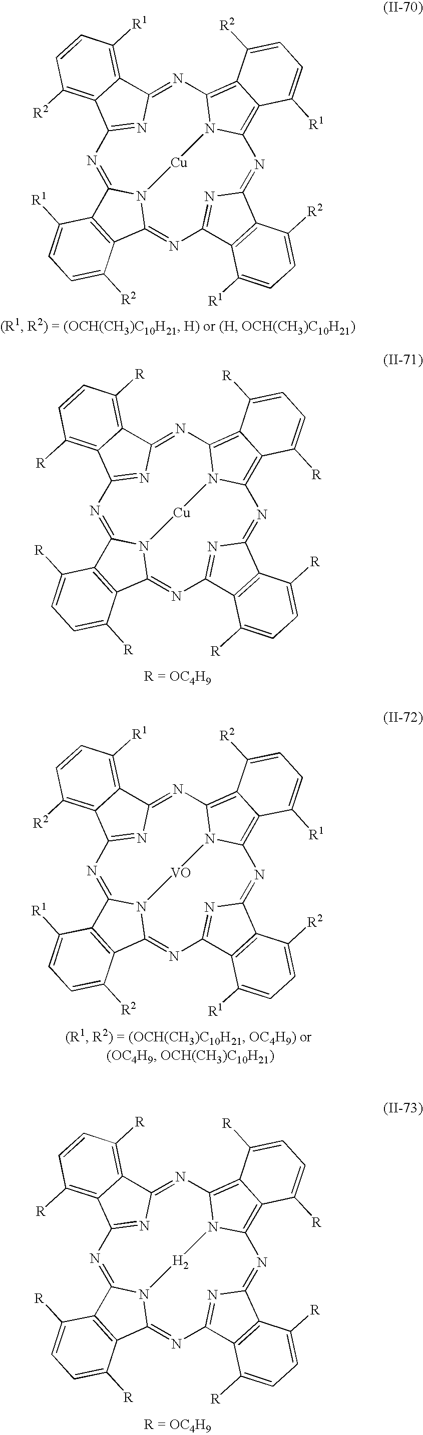

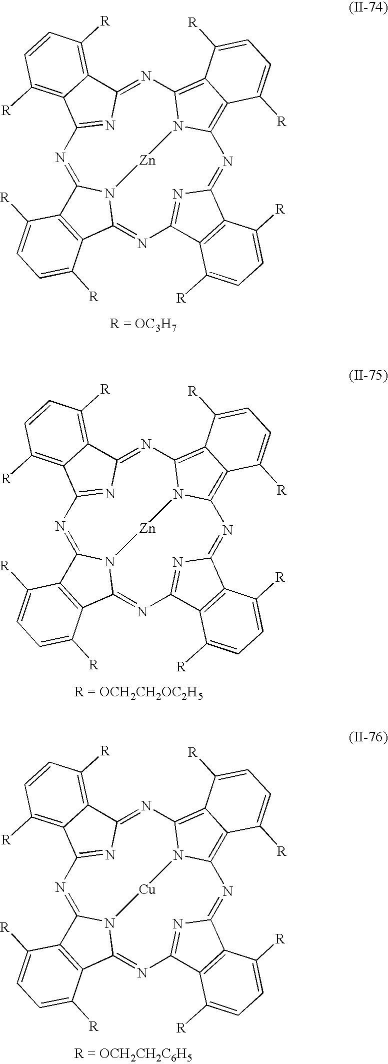

The compounds above can be synthesized easily according to the methods described in Chemistry A, European Journal, Vol. 9, pp. 5123 to 5134 (issued in 2003) or methods similar to those. For example, a phthalocyanine compound having a metal at the center can be prepared directly from the corresponding phthalic acid or the derivative thereof (acid anhydride, diamide, dinitrile, or the like) in the presence of the metal compound. A catalyst (e.g., ammonium molybdenate) and urea are preferably present at the same time. Alternatively, it can also be synthesized by using a metal compound as described below, after a nonmetal derivative of the phthalocyanine is once prepared by using a lithium compound, and the method is particularly preferable for preparation of a metal derivative of naphthalocyanine. More specifically when a phthalocyanine nonmetal derivative and a metal compound are used, the ratio of the raw materials, i.e., preferable amount ratio of the metal compound to 1 mole of the phthalocyanine nonmetal derivative, is preferably 0.1 to 10 moles, more preferably 0.5 to 5 moles, and still more preferably 1 to 3 moles. The metal compound may be an inorganic or organic metal compound, and examples thereof include halides (e.g., chlorides, bromides), sulfate salts, nitrate salts, cyanates, acetate salts, metal acetylacetonates, and the like; preferable are chlorides, sulfate salts, cyanate salts, and acetate salts; more preferable are chlorides and acetate salts; and most preferable are acetate salts.

Examples of the solvents for use in the reaction include amide-based solvents (such as N,N-dimethylformamide, N,N-dimethylacetamide, and 1-methyl-2-pyrrolidone), sulfone-based solvents (such as sulfolane), sulfoxide-based solvents (such as dimethylsulfoxide), ether-based solvents (such as dioxane and cyclopentylmethylether), ketone-based solvents (such as acetone and cyclohexanone), hydrocarbon-based solvents (such as toluene and xylene), halogenated solvents (such as tetrachloroethane and chlorobenzene), alcohol-based solvents (such as 1-butanol, ethylene glycol, and cyclohexanol), hydrocarbon-based solvents, and halogenated solvents; more preferable are ether-based solvents, hydrocarbon-based solvents, and halogenated solvents; still more preferable are halogenated solvents; and chlorobenzene is most preferable. The reaction temperature is −30 to 250° C., preferably 0 to 200° C., more preferably 20 to 150° C., and still more preferably 50 to 100° C.; and the reaction time is in the range of 5 minutes to 30 hours.

In the invention, the total amount of the compounds defined in “at least two ultraviolet absorbents” is preferably 0.1 mole or more, more preferably 0.05 to 2 moles, more preferably 0.1 to 1.0 mole, and most preferably 0.1 to 0.5 mole with respect to 1 mole of the compound defined in “at least one near-infrared absorbent or infrared absorbent” for use as near-infrared-absorbing material.

The near-infrared-absorbing material according to the invention can be used in various applications as a near-infrared-absorbing material, as the compounds defined in “at least two ultraviolet absorbents” and “at least one near-infrared absorbent or infrared absorbent” are coated, kneaded, hard-coated, or polymerized with a suitable monomer on a substrate such as paper, resin sheet, resin, film, glass, or metal plate, as they are or as dissolved in solution, or in combination with a binder and other compounds. Specific applications thereof include optical recording medium for long-wavelength laser, recording material for invisible printing, optical filter, construction and agricultural filter, painting material, and others. Preferable among them are applications as optical filter, construction and agricultural filter, painting material, and others, and more preferable is an application as optical filter.

The near-infrared-absorbing material according to the invention is prepared, for example, by dissolving the compounds defined in “at least two ultraviolet absorbents” and “at least one near-infrared absorbent or infrared absorbent” in a solvent (such as chloroform, methylene chloride, toluene, acetone, methylethylketone, cyclohexanone, ethyl acetate, dibutylether, tetrahydrofuran, or dimethylformamide), kneading them under heat with a resin (such as ABS resin, polyethylene resin, polypropylene resin, polyvinyl chloride resin, polycarbonate resin, polystyrene resin, polyacrylonitrile resin, methacrylonitrile resin, polymethacrylic ester resin, or polyester resin), or dissolving them in the solvent, adding the resin thereto additionally and heating the mixture to solubilization; and then forming a thin film by applying the compounds, for example, on a resin film described above as it is or as dissolved or dispersed in a solvent.

The near-infrared-absorbing compound according to the invention is superior both in light resistance and other physical properties, and can be used also in various other new applications.

### EXAMPLES

Hereinafter, the present invention will be described in more detail with reference to Examples, however it should be understood that the invention is not limited thereto.

In the Examples below, the two kinds of compounds defined in “at least two ultraviolet absorbents” of the invention will be referred to, for convenience, as compounds (Ia) and (Ib), and the compound defined in “at least one near-infrared absorbent or infrared absorbent”, as a compound (II).

### Example 1

### Preparation of Near-Infrared-Absorbing Filter

A solution of 10 g of polystyrene, the compound defined in “at least two ultraviolet absorbents” in the amount shown in the following Table 1, and 0.1 g the compound defined in “at least one near-infrared absorbent or infrared absorbent” (compound (II-1)) in 100 ml of chloroform 100 ml, which was stirred previously at 40° C. for 15 minutes, was applied on a glass plate and dried at room temperature under air stream, to give a sample.

Light Resistance Test

The sample obtained was irradiated with a xenon lamp at 95,000 lux for three days, the absorption at the maximum spectroscopic absorption wavelength of the compound (II-1) before and after irradiation was determined, and the light fastness was evaluated from the retention ratio thus obtained.

TABLE 1

| | Compound (I-a) | | Compound (I-b) | | | |
|---|---|---|---|---|---|---|
| | | Molar ratio | | Molar ratio | Light | |
| Test number | Structure | to (II-1) | Structure | to (II-1) | resistance | Remarks |
| 156 | | | (I-93) | 0.05 | 0.12 | Comparative example |
| 157 | | | (I-93) | 0.1 | 0.18 | Comparative example |
| 158 | | | (I-93) | 0.2 | 0.24 | Comparative example |
| 159 | | | (I-93) | 0.4 | 0.31 | Comparative example |
| 160 | | | (I-93) | 1 | 0.32 | Comparative example |
| 161 | (I-9) | 0.025 | (I-93) | 0.025 | 0.13 | The invention |
| 162 | (I-9) | 0.05 | (I-93) | 0.05 | 0.5 | The invention |
| 163 | (I-9) | 0.1 | (I-93) | 0.1 | 0.55 | The invention |
| 164 | (I-9) | 0.2 | (I-93) | 0.2 | 0.62 | The invention |
| 165 | (I-9) | 0.5 | (I-93) | 0.5 | 0.63 | The invention |

TABLE 2

| | Compound (I-a) | | Compound (I-b) | | | |
|---|---|---|---|---|---|---|
| | | Molar ratio | | Molar ratio | Light | |
| Test number | Structure | to (II-1) | Structure | to (II-1) | resistance | Remarks |
| 116 | | | (I-18) | 0.05 | 0.13 | Comparative example |
| 117 | | | (I-18) | 0.1 | 0.32 | Comparative example |
| 118 | | | (I-18) | 0.2 | 0.4 | Comparative example |
| 119 | | | (I-18) | 0.4 | 0.43 | Comparative example |
| 120 | | | (I-18) | 1 | 0.46 | Comparative example |
| 121 | (I-9) | 0.025 | (I-18) | 0.025 | 0.12 | The invention |
| 122 | (I-9) | 0.05 | (I-18) | 0.05 | 0.44 | The invention |
| 123 | (I-9) | 0.1 | (I-18) | 0.1 | 0.49 | The invention |
| 124 | (I-9) | 0.2 | (I-18) | 0.2 | 0.53 | The invention |
| 125 | (I-9) | 0.5 | (I-18) | 0.5 | 0.55 | The invention |
| 126 | | | (I-41) | 0.05 | 0.11 | Comparative example |
| 127 | | | (I-41) | 0.1 | 0.25 | Comparative example |
| 128 | | | (I-41) | 0.2 | 0.3 | Comparative example |
| 129 | | | (I-41) | 0.4 | 0.33 | Comparative example |
| 130 | | | (I-41) | 1 | 0.36 | Comparative example |
| 131 | (I-9) | 0.025 | (I-41) | 0.025 | 0.14 | The invention |
| 132 | (I-9) | 0.05 | (I-41) | 0.05 | 0.58 | The invention |
| 133 | (I-9) | 0.1 | (I-41) | 0.1 | 0.63 | The invention |
| 134 | (I-9) | 0.2 | (I-41) | 0.2 | 0.69 | The invention |
| 135 | (I-9) | 0.5 | (I-41) | 0.5 | 0.71 | The invention |

TABLE 3

| | Compound (I-a) | | Compound (I-b) | | | |
|---|---|---|---|---|---|---|
| | | Molar ratio | | Molar ratio | Light | |
| Test number | Structure | to (II-1) | Structure | to (II-1) | resistance | Remarks |
| 136 | | | (I-52) | 0.05 | 0.11 | Comparative example |
| 137 | | | (I-52) | 0.1 | 0.24 | Comparative example |
| 138 | | | (I-52) | 0.2 | 0.28 | Comparative example |
| 139 | | | (I-52) | 0.4 | 0.3 | Comparative example |
| 140 | | | (I-52) | 1 | 0.39 | Comparative example |
| 141 | (I-9) | 0.025 | (I-52) | 0.025 | 0.14 | The invention |
| 142 | (I-9) | 0.05 | (I-52) | 0.05 | 0.55 | The invention |
| 143 | (I-9) | 0.1 | (I-52) | 0.1 | 0.61 | The invention |
| 144 | (I-9) | 0.2 | (I-52) | 0.2 | 0.67 | The invention |
| 145 | (I-9) | 0.5 | (I-52) | 0.5 | 0.68 | The invention |
| 146 | | | (I-71) | 0.05 | 0.12 | Comparative example |
| 147 | | | (I-71) | 0.1 | 0.2 | Comparative example |
| 148 | | | (I-71) | 0.2 | 0.3 | Comparative example |
| 149 | | | (I-71) | 0.4 | 0.32 | Comparative example |
| 150 | | | (I-71) | 1 | 0.34 | Comparative example |
| 151 | (I-9) | 0.025 | (I-71) | 0.025 | 0.12 | The invention |
| 152 | (I-9) | 0.05 | (I-71) | 0.05 | 0.49 | The invention |
| 153 | (I-9) | 0.1 | (I-71) | 0.1 | 0.57 | The invention |
| 154 | (I-9) | 0.2 | (I-71) | 0.2 | 0.63 | The invention |
| 155 | (I-9) | 0.5 | (I-71) | 0.5 | 0.66 | The invention |

TABLE 4

| | Compound (I-a) | | Compound (I-b) | | | |
|---|---|---|---|---|---|---|
| | | Molar ratio | | Molar ratio | Light | |
| Test number | Structure | to (II) | Structure | to (II) | resistance | Remarks |
| 156 | | | (I-93) | 0.05 | 0.12 | Comparative example |
| 157 | | | (I-93) | 0.1 | 0.18 | Comparative example |
| 158 | | | (I-93) | 0.2 | 0.24 | Comparative example |
| 159 | | | (I-93) | 0.4 | 0.31 | Comparative example |
| 160 | | | (I-93) | 1 | 0.32 | Comparative example |
| 161 | (I-9) | 0.025 | (I-93) | 0.025 | 0.13 | The invention |
| 162 | (I-9) | 0.05 | (I-93) | 0.05 | 0.5 | The invention |
| 163 | (I-9) | 0.1 | (I-93) | 0.1 | 0.55 | The invention |
| 164 | (I-9) | 0.2 | (I-93) | 0.2 | 0.62 | The invention |
| 165 | (I-9) | 0.5 | (I-93) | 0.5 | 0.63 | The invention |

As apparent from the Table 1, all the samples according to the invention were superior in durability (light resistance). In particular, combined use of two or more compounds defined in “at least two ultraviolet absorbents” at the same total added mole number was more favorable in light resistance and much greater in effect than single use of one of the compounds defined in “at least two ultraviolet absorbents” above in all cases. Such a significant effect could not have been predicted.

### Example 2

### Preparation of Near-Infrared-Absorbing Filter

A solution of 10 g of polystyrene, the compound defined in 1) above in the amount shown in the following Table 1, and 0.1 g the compound 2) defined above (compound (II-1)) in 100 ml of chloroform 100 ml, which was stirred previously at 40° C. for 15 minutes, was applied on a glass plate and dried at room temperature under air stream, to give a sample.

(Light Resistance Test)

The sample obtained was irradiated with a xenon lamp at 950,000 lux for three days, the absorption at the maximum spectroscopic absorption wavelength of the compound (II-1) before and after irradiation was determined, and the light fastness was evaluated from the retention ratio thus obtained.

TABLE 5

| | Compound (I-a) | | Compound (I-b) | | | | |
|---|---|---|---|---|---|---|---|
| Test | | Molar ratio | | Molar ratio | Structure of | Light | |
| number | Structure | to (II) | Structure | to (II) | compound (II) | resistance | Remarks |
| 200 | None | | | | (II-4) | 0.12 | Comparative example |
| 201 | (I-11) | 0.05 | None | | (II-4) | 0.13 | Comparative example |
| 202 | (I-11) | 0.1 | None | | (II-4) | 0.19 | Comparative example |
| 203 | (I-11) | 0.2 | None | | (II-4) | 0.38 | Comparative example |
| 204 | (I-11) | 0.4 | None | | (II-4) | 0.40 | Comparative example |
| 205 | (I-11) | 1 | None | | (II-4) | 0.49 | Comparative example |
| 206 | None | | (I-41) | 0.05 | (II-4) | 0.11 | Comparative example |
| 207 | None | | (I-41) | 0.1 | (II-4) | 0.23 | Comparative example |
| 208 | None | | (I-41) | 0.2 | (II-4) | 0.32 | Comparative example |
| 209 | None | | (I-41) | 0.4 | (II-4) | 0.35 | Comparative example |
| 210 | None | | (I-41) | 1 | (II-4) | 0.40 | Comparative example |
| 211 | (I-11) | 0.025 | (I-41) | 0.025 | (II-4) | 0.17 | The invention |
| 212 | (I-11) | 0.05 | (I-41) | 0.05 | (II-4) | 0.55 | The invention |
| 213 | (I-11) | 0.1 | (I-41) | 0.1 | (II-4) | 0.62 | The invention |
| 214 | (I-11) | 0.2 | (I-41) | 0.2 | (II-4) | 0.69 | The invention |
| 215 | (I-11) | 0.5 | (I-41) | 0.5 | (II-4) | 0.77 | The invention |

TABLE 6

| | Compound (I-a) | | Compound (I-b) | | | | |
|---|---|---|---|---|---|---|---|
| Test | | Molar ratio | | Molar ratio | Structure of | Light | |
| number | Structure | to (II) | Structure | to (II) | compound (II) | resistance | Remarks |
| 216 | (I-57) | 0.05 | None | | (II-4) | 0.18 | Comparative example |
| 217 | (I-57) | 0.1 | None | | (II-4) | 0.2 | Comparative example |
| 218 | (I-57) | 0.2 | None | | (II-4) | 0.35 | Comparative example |
| 219 | (I-57) | 0.4 | None | | (II-4) | 0.39 | Comparative example |
| 220 | (I-57) | 1 | None | | (II-4) | 0.44 | Comparative example |
| 221 | (I-57) | 0.025 | (I-41) | 0.025 | (II-4) | 0.18 | The invention |
| 222 | (I-57) | 0.05 | (I-41) | 0.05 | (II-4) | 0.28 | The invention |
| 223 | (I-57) | 0.1 | (I-41) | 0.1 | (II-4) | 0.49 | The invention |
| 224 | (I-57) | 0.2 | (I-41) | 0.2 | (II-4) | 0.52 | The invention |
| 225 | (I-57) | 0.5 | (I-41) | 0.5 | (II-4) | 0.54 | The invention |
| 226 | None | | None | | (II-4) | 0.09 | Comparative example |
| 227 | (I-18) | 0.05 | None | | (II-4) | 0.1 | Comparative example |
| 228 | (I-18) | 0.1 | None | | (II-4) | 0.21 | Comparative example |
| 229 | (I-18) | 0.2 | None | | (II-4) | 0.33 | Comparative example |
| 230 | (I-18) | 0.4 | None | | (II-4) | 0.41 | Comparative example |
| 231 | (I-18) | 1 | None | | (II-4) | 0.47 | Comparative example |

TABLE 7

| | Compound (I-a) | | Compound (I-b) | | | | |
|---|---|---|---|---|---|---|---|
| Test | | Molar ratio | | Molar ratio | Structure of | Light | |
| number | Structure | to (II) | Structure | to (II) | compound (II) | resistance | Remarks |
| 232 | None | | (I-71) | 0.05 | (II-10) | 0.15 | Comparative example |
| 233 | None | | (I-71) | 0.1 | (II-10) | 0.22 | Comparative example |
| 234 | None | | (I-71) | 0.2 | (II-10) | 0.29 | Comparative example |
| 235 | None | | (I-71) | 0.4 | (II-10) | 0.33 | Comparative example |
| 236 | None | | (I-71) | 1 | (II-10) | 0.38 | Comparative example |
| 237 | (I-18) | 0.025 | (I-71) | 0.025 | (II-10) | 0.17 | The invention |
| 238 | (I-18) | 0.05 | (I-71) | 0.05 | (II-10) | 0.49 | The invention |
| 239 | (I-18) | 0.1 | (I-71) | 0.1 | (II-10) | 0.61 | The invention |
| 240 | (I-18) | 0.2 | (I-71) | 0.2 | (II-10) | 0.66 | The invention |
| 241 | (I-18) | 0.5 | (I-71) | 0.5 | (II-10) | 0.71 | The invention |
| 242 | None | | None | | (II-32) | 0.03 | Comparative example |
| 243 | (I-47) | 0.05 | None | | (II-32) | 0.04 | Comparative example |
| 244 | (I-47) | 0.1 | None | | (II-32) | 0.1 | Comparative example |
| 245 | (I-47) | 0.2 | None | | (II-32) | 0.13 | Comparative example |
| 246 | (I-47) | 0.4 | None | | (II-32) | 0.17 | Comparative example |
| 247 | (I-47) | 1 | None | | (II-32) | 0.2 | Comparative example |
| 248 | None | | (I-17) | 0.05 | (II-32) | 0.06 | Comparative example |
| 249 | None | | (I-17) | 0.1 | (II-32) | 0.14 | Comparative example |
| 250 | None | | (I-17) | 0.2 | (II-32) | 0.19 | Comparative example |
| 251 | None | | (I-17) | 0.4 | (II-32) | 0.23 | Comparative example |
| 252 | None | | (I-17) | 1 | (II-32) | 0.27 | Comparative example |
| 253 | (I-47) | 0.025 | (I-17) | 0.025 | (II-32) | 0.08 | The invention |
| 254 | (I-47) | 0.05 | (I-17) | 0.05 | (II-32) | 0.3 | The invention |
| 255 | (I-47) | 0.1 | (I-17) | 0.1 | (II-32) | 0.39 | The invention |
| 256 | (I-47) | 0.2 | (I-17) | 0.2 | (II-32) | 0.43 | The invention |
| 257 | (I-47) | 0.5 | (I-17) | 0.5 | (II-32) | 0.49 | The invention |

Physical properties of the compounds used in Examples of the invention are shown in Table 8.

TABLE 8

| Compound | λ max (ε) | Measurement solvent |
|---|---|---|
| I-9 | 349 nm (1.52 × 10⁴) | Ethyl acetate |
| I-11 | 348 nm (1.67 × 10⁴) | Ethyl acetate |
| I-14 | 348 nm (1.66 × 10⁴) | Ethyl acetate |
| I-17 | 338 nm (1.59 × 10⁴) | Ethyl acetate |
| I-18 | 339 nm (1.62 × 10⁴) | Ethyl acetate |
| I-41 | 351 nm (1.91 × 10⁴) | Ethyl acetate |
| I-47 | 353 nm (2.01 × 10⁴) | Ethyl acetate |
| I-52 | 308 nm (4.70 × 10³) | N,N-Dimethylformamide |
| I-57 | 309 nm (4.30 × 10³) | N,N-Dimethylformamide |
| I-71 | 299 nm (1.28 × 10⁴) | Ethyl acetate |
| I-93 | 297 nm (1.45 × 10⁴) | Ethyl acetate |
| II-1 | 924 nm | Sulfuric acid |
| II-4 | 843 nm | Tetrahydrofuran |
| II-10 | 842 nm | Tetrahydrofuran |
| II-32 | 828 nm | Tetrahydrofuran |

As apparent from Tables 1 to 7, results of the test with varying compounds (II) were similar to those in Example 1. Such a significant effect of combined use of these absorbents in the invention could not have been predicted.

1-13. (canceled)

14. A process of preparing a near-infrared absorbing film comprising the steps of, in order,
dissolving in a solvent at least two ultraviolet absorbents, at least one absorbent selected from the group consisting of a near-infrared absorbent and an infrared absorbent and a resin to form a coating solution;
forming a film of said solution; and
drying said film of the solution, thereby obtaining the near-infrared absorbing film.

15. The process of claim 14, wherein the at least two ultraviolet absorbents are at least two compounds having a maximum spectroscopic absorption wavelength in solution of 470 nm or less in a wavelength range of from 270 to 1,600 nm.

16. The process of claim 14, wherein the at least one absorbent selected from the group consisting of a near-infrared absorbent and an infrared absorbent is at least one compound having a maximum spectroscopic absorption wavelength in solution of 700 nm or more in a wavelength range of from 400 to 1,600 nm n.

17. The process of claim 14, wherein the at least two ultraviolet absorbents have a maximum spectroscopic absorption wavelength of 430 nm or less and the at least one absorbent selected from the group consisting of a near-infrared absorbent and an infrared absorbent has a maximum spectroscopic absorption wavelength of 730 nm or more.

18. The process of claim 17, wherein the at least two ultraviolet absorbents have a maximum spectroscopic absorption wavelength of 410 nm or less and the at least one near-infrared absorbent or infrared absorbent has a maximum spectroscopic absorption wavelength of 760 nm or more.

19. The process of claim 18, wherein the at least two ultraviolet absorbents have a maximum spectroscopic absorption wavelength of 380 nm or less and the at least one near-infrared absorbent or infrared absorbent has a maximum spectroscopic absorption wavelength of 780 nm or more.

20. The process of claim 15, wherein the at least two ultraviolet absorbents are compounds selected from compounds represented by the following Formulae (I-1), (I-2), (I-3), (I-4) and (I-5): 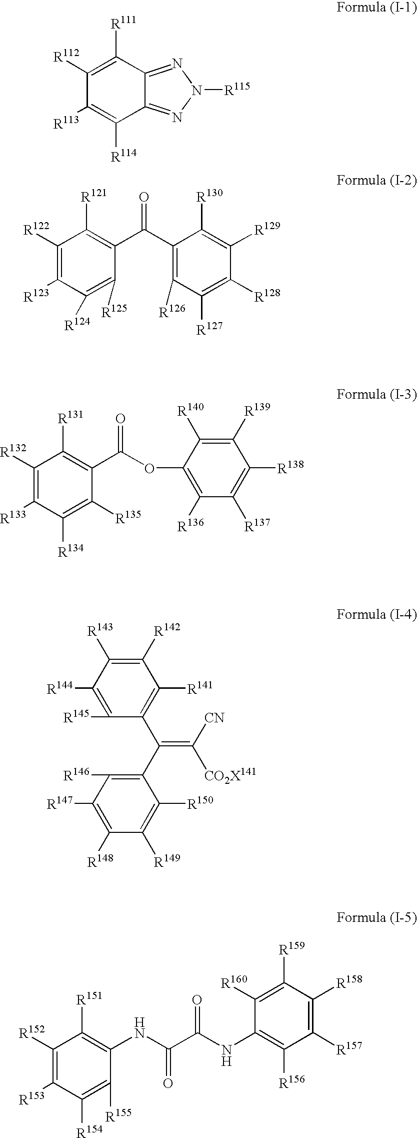
wherein, in Formulae (I-1) to (I-5), R¹¹¹ to R¹¹⁴, R¹²¹ to R¹³⁰, R¹³¹ to R¹⁴⁰, R¹⁴¹ to R¹⁵⁰, and R¹⁵¹ to R¹⁶⁰ each independently represent a hydrogen atom or a substituent group; R¹¹⁵ represents a hydrogen atom, an aliphatic group, an aromatic group or a heterocyclic group binding at a carbon atom; X¹⁴¹ represents a hydrogen atom, an aliphatic group, an aromatic group or a heterocyclic group binding at a carbon atom; and among R¹¹¹ to R¹¹⁴, R¹²¹ to R¹³⁰, R¹³¹ to R¹⁴⁰, R¹⁴¹ to R¹⁵⁰, and R¹⁵¹ to R¹⁶⁰, neighboring substituent groups on a benzene ring in each Formula may bind to each other to form a ring.

21. The process of claim 20, wherein the at least two ultraviolet absorbents are a combination of compounds respectively selected from the different Formula selected from the Formulae (I-1) to (I-5).

22. The process of claim 20, wherein the at least two ultraviolet absorbents include at least one compound represented by the Formula (I-1).

23. The process of claim 21, wherein the at least two ultraviolet absorbents include at least one compound selected from the group consisting of Formulae (I-2), (I-3), (I-4) and (I-5).

24. The process of claim 15, wherein the at least one absorbent selected from the group consisting of a near-infrared absorbent and an infrared absorbent is a compound represented by the following Formula (I-1): 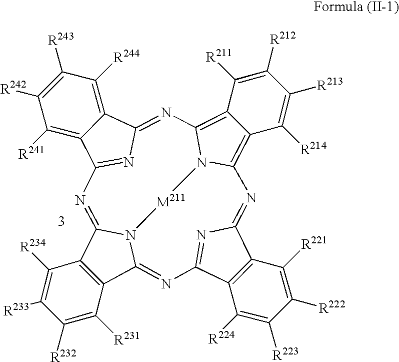
wherein, in Formula (II-1), R²¹¹ to R²⁴⁴ each independently represent a hydrogen atom or a substituent group; among R²¹¹ to R²⁴⁴, neighboring substituent groups on a benzene ring may bind to each other to form a ring; M²¹¹ represents two atoms selected from the group consisting of a hydrogen atom and monovalent metal atoms, a divalent metal atom, or a divalent substituted metal atom including a trivalent or quadrivalent metal atom.

25. The process of claim 15, wherein the at least two ultraviolet absorbents and the at least one absorbent selected from the group consisting of a near-infrared absorbent and an infrared absorbent are present in a single layer.

26. The process of claim 15, wherein the total mole number of the at least two ultraviolet absorbents is 0.1 mole or more with respect to 1 mole of the at least one absorbent selected from the group consisting of a near-infrared absorbent and an infrared absorbent.
